(19) United States
(12) Patent Application Publication
(10) Pub. No.: US 2020/0036175 A1
(43) Pub. Date: Jan. 30, 2020

(54) DEVICE MOUNTING APPARATUS, KITS, METHODS, AND SYSTEMS

(71) Applicant: PRIMEX MANUFACTURING LTD., Langley (CA)

(72) Inventors: HONG CHEN, RICHMOND (CA); NATHAN CHENG, VANCOUVER (CA); CINDI FENG, SURREY (CA); CHRISTIAN GUCKEL, LANGLEY (CA); DONOVAN HAMMERSLEY, WHITE ROCK (CA); BALIN LEE, PORT MOODY (CA); YIN FUN (EVA) SUN, LANGLEY (CA); KAI ZHANG, LANGLEY (CA)

(21) Appl. No.: 16/523,963

(22) Filed: Jul. 26, 2019

Related U.S. Application Data
(60) Provisional application No. 62/711,472, filed on Jul. 27, 2018.

(51) Int. Cl. H02G 3/08; H02G 3/14; H02G 3/12; H02G 3/16

(52) U.S. Cl. CPC H02G 3/083; H02G 3/16; H02G 3/12; H02G 3/14

(57) ABSTRACT

A system according to at least one embodiment comprises a body comprising a plurality of support surfaces. The system further comprises an apparatus comprising a plurality of connector surfaces, each connector surface of the plurality of connector surfaces being engageable with a respective support surface of the plurality of support surfaces, wherein, when any one connector surface of the plurality of connector surfaces is engaged with its respective support surface of plurality of support surfaces, a multi-axis hinge associated with the one connector surface permits movement of the apparatus relative to the body about a plurality of different axes of rotation for the multi-axis hinge.

### RELATED APPLICATIONS

This application claims the benefit of U.S. Provisional Patent Application No. 62/711,472, filed Jul. 27, 2018, entitled “DEVICE MOUNTING APPARATUS, KITS, METHODS, AND SYSTEMS, the entirety of which is hereby incorporated by reference herein.

### TECHNICAL FIELD

Aspects of the present disclosure may relate to device mounting apparatus, kits, methods, and systems.

### BACKGROUND

The use of electronic devices and cables in single residences, multiple-dwelling units and commercial premises, necessitates the use of networking bodies mounted on or in walls or other locations of the premises. A plurality of electronic devices may be mounted in such bodies. Effectively mounting these devices in such bodies without comprising their performance and/or tangling their respective cables is a known problem.

### SUMMARY

Aspects of this disclosure are directed to device mounting apparatus, kits, methods, and systems. Numerous exemplary aspects are described.

According to at least one embodiment, there is provided a system comprising: a body comprising a plurality of support surfaces; and an apparatus comprising a plurality of connector surfaces, each connector surface of the plurality of connector surfaces being engageable with a respective support surface of the plurality of support surfaces, wherein, when any one connector surface of the plurality of connector surfaces is engaged with its respective support surface of plurality of support surfaces, a multi-axis hinge associated with the one connector surface permits movement of the apparatus relative to the body about a plurality of different axes of rotation for the multi-axis hinge.

In some embodiments, the body comprises one or more body surfaces defining an interior cavity and the apparatus is receivable in the interior cavity.

In some embodiments, the system comprises a plurality of connector surfaces engageable with the one or more body surfaces. In some embodiments, each support surface of the plurality of support surfaces is located on a respective connector surface of the plurality of connector surfaces.

In some embodiments: the one or more body surfaces comprise a plurality of mounting structures; and each connector surface of the plurality of connector surfaces is engageable with a respective mounting structure of the plurality of mounting structures.

In some embodiments: the body comprises a lid operable to enclose the interior cavity; and the lid comprises the plurality of support surfaces.

In some embodiments: the plurality of support surfaces comprise a first support surface and a second support surface, and the plurality of connector surfaces comprise a first connector surface and a second connector surface; and the first and second support surfaces are engageable with the first and second connector surfaces to permit movement of the apparatus relative to the body about a first axis of rotation for the multi-axis hinge.

In some embodiments: the plurality of support surfaces comprise a third support surface, and the plurality of connector surfaces comprise a third connector surface; and the first and third support surfaces are engageable with the first and third connector surfaces to permit movement of the apparatus relative to the body about a second axis of rotation for the multi-axis hinge.

In some embodiments: the plurality of support surfaces comprise a fourth support surface, and the plurality of connector surfaces comprise a fourth connector surface; and the third and fourth support surfaces are engageable with the third and fourth connector surfaces to permit movement of the apparatus relative to the body about a third axis of rotation for the multi-axis hinge.

In some embodiments, the first and fourth support surfaces are engageable with the first and fourth connector surfaces to permit movement of the apparatus relative to the body about a fourth axis of rotation for the multi-axis hinge.

In some embodiments, the first axis is parallel with the third axis and the second axis is parallel with the fourth axis.

In some embodiments, the multi-axis hinge comprises a ball-and-socket joint.

In some embodiments, the multi-axis hinge is formed when the one connector surface is engaged with its respective support surface.

In some embodiments, at least a portion of the plurality of support surfaces are linearly adjustable relative to a body surface of the body in order to modify a distance between the multi-axis hinge and the body surface.

In some embodiments, the plurality of support surfaces comprise: a plurality of first fixed-length supports configured to offset the multi-axis hinge from a body surface of the body by a first distance; and a plurality of second fixed-length supports configured to offset the multi-axis hinge from the body surface by a second distance.

In some embodiments, each of the plurality of connector surfaces is engageable with each of the plurality of support surfaces.

In some embodiments, the apparatus comprises a first apparatus portion, a second apparatus portion, and a frangible portion joining the first and second portions.

In some embodiments, the apparatus comprises: first securing slots located in an interior portion of the apparatus and operable with an attachment element to secure objects to a front side of the apparatus; second securing slots located in the interior portion and operable with the attachment element to secure the objects to a back side of the apparatus; and third securing slots located on a perimeter of the interior portion and operable with the attachment element to secure the objects to the front or back side of the apparatus, each third slot having a longitudinal dimension that is greater than a respective longitudinal dimension of each first and second slot.

According to at least one embodiment, there is provided a kit comprising: at least one body comprising a plurality of support surfaces; and at least one apparatus comprising a plurality of connector surfaces, each connector surface of the plurality of connector surfaces being engageable with a respective support surface of the plurality of support surfaces, wherein, when any one connector surface of the plurality of connector surfaces of any apparatus is engaged with its respective support surface of plurality of support surfaces of any body, a multi-axis hinge associated with the one connector surface permits movement of the apparatus relative to the body about a plurality of different axes of rotation for the multi-axis hinge.

In some embodiments, the kit comprises at least one of: an attachment element operable to secure the body to another surface; an attachment element operable to secure objects to the apparatus; and instructions associated with the body or the apparatus.

According to at least one embodiment, there is provided a system comprising: a body comprising a plurality of support surfaces; and an apparatus comprising a plurality of connector surfaces, each connector surface of the plurality of connector surfaces being engageable with a respective support surface of the plurality of support surfaces, wherein, when any one connector surface of the plurality of connector surfaces is engaged with its respective support surface of plurality of support surfaces, a hinge means for moving the apparatus relative to the body permits movement of the apparatus relative to the body about a plurality of different axes of rotation for the hinge means.

Additional methods, kits, and systems may be described with reference to the aspects described herein and/or inherent to those descriptions.

It may be understood that both the foregoing summary and the following detailed written descriptions are exemplary and explanatory only, neither being restrictive of the inventions claimed below. In addition to the exemplary aspects described above, further aspects will become apparent by reference to the drawings and by study of the following detailed descriptions.

### BRIEF DESCRIPTION OF THE DRAWINGS

The accompanying drawings, which are incorporated in and constitute part of this disclosure, illustrate exemplary aspects that, together with the written descriptions, serve to explain the principles of this disclosure. Numerous aspects are particularly described, pointed out, and distinctively claimed in the written descriptions. Some structural and operational aspects may be even better understood by referencing these descriptions together with the accompanying drawings, of which:

FIG. 1 depicts a perspective, exploded view of an exemplary system comprising illustrative examples of a lid, a body, an apparatus, a hinges, and objects secured to the apparatus with attachment elements.

FIG. 2 depicts a perspective, partially assembled view of the FIG. 1 system, in which the lid is offset from the body and the apparatus is rotatably secured to the body with the hinges.

FIG. 3 depicts a perspective view of the FIG. 1 apparatus.

FIG. 4 depicts a perspective view of a front side of a portion of FIG. 3 apparatus.

FIG. 5 depicts a perspective view of a back side of a portion of FIG. 3 apparatus.

FIG. 6A depicts a perspective, partially assembled front view of a means for joining different portions of the FIG. 3 apparatus.

FIG. 6B depicts another perspective, partially assembled front view of a means for joining different portions of the FIG. 3 apparatus.

FIG. 7A depicts a perspective view of a variable-length support in a collapsed configuration for locating the apparatus at a first distance relative to a back surface of the body.

FIG. 7B depicts a perspective view of the FIG. 7A support in an extended configuration for locating the apparatus at a second distance relative to the back surface.

FIG. 7C depicts a perspective, close-up view of the FIG. 7A support.

FIG. 8A depicts a perspective view of another variable-length support in a collapsed configuration for locating the apparatus at the first distance.

FIG. 8B depicts a perspective view of the FIG. 8A support in an extended configuration for locating the apparatus at the second distance.

FIG. 8C depicts a perspective view of a fixed-length support for locating the apparatus at the first distance.

FIG. 8D depicts a perspective view of another fixed-length support for locating the apparatus at the second distance.

FIG. 9 depicts a perspective, partially assembled view of the FIG. 1 system, in which the apparatus is rotatably secured in the body and rotated relative to a back surface of the body about an (e.g., vertical) axis.

FIG. 10 depicts a front view of the FIG. 1 system, in which the apparatus is maintained in a closed configuration.

FIG. 11A depicts a front view of the FIG. 3 apparatus secured at a first location in the body.

FIG. 11B depicts a front view of the FIG. 3 apparatus secured at a second location in the body.

FIG. 12A depicts a front view of a first FIG. 3 apparatus secured at the first location and a second FIG. 4 apparatus secured at the second location.

FIG. 12B depicts a side view of the FIG. 12A system, in which the first apparatus at the first location is spaced apart from a back surface of the body by a first distance and the second apparatus at the second location is spaced apart from the back surface by a second distance different (e.g., larger) from the first distance.

FIG. 13 depicts a perspective, partially assembled view of the FIG. 1 system, in which the FIG. 3 apparatus is rotatably secured in the body and rotated relative to the back surface about a first (e.g., vertical) axis.

FIG. 14 depicts a perspective, partially assembled view of the FIG. 9 system, in which the apparatus is rotatably secured in the body and rotated relative to the back surface about a second (e.g., horizontal) axis.

FIG. 15 depicts a perspective, exploded view of another system comprising additional illustrative examples of a lid, a body, an apparatus, and supports.

FIG. 16 depicts a front view of a front side of the FIG. 15 apparatus.

FIG. 17A depicts a perspective view of a fixed-length support for locating the FIG. 15 apparatus at a first distance relative to a back surface of the body.

FIG. 17B depicts a perspective view of another fixed-length support for locating the FIG. 15 apparatus at a second distance relative to the back surface.

FIG. 18A depicts a front view of the FIG. 15 body.

FIG. 18B depicts a perspective, close-up view of a corner of the FIG. 15 body.

FIG. 19 depicts a perspective, exploded view of the FIG. 15 support.

FIG. 20 depicts a perspective, assembled view of the FIG. 15 support.

FIG. 21 depicts a perspective, partially assembled view of the FIG. 15 system, in which the apparatus is maintained in a closed configuration.

FIG. 22A depicts a perspective, partially assembled view of the FIG. 15 system, in which the apparatus is rotated relative to the back surface of the body about a first (e.g., horizontal) axis of the hinges.

FIG. 22B depicts a perspective, partially assembled view of the FIG. 15 system, in which the apparatus is rotated relative to the back surface about a second (e.g., horizontal) axis of the hinges.

FIG. 22C depicts a perspective, partially assembled view of the FIG. 15 system, in which the apparatus is rotated relative to the back surface about a third (e.g., vertical) axis of the hinges.

FIG. 22D depicts a perspective, partially assembled view of the FIG. 15 system, in which the apparatus is rotated relative to the back surface about a fourth (e.g., vertical) axis of the hinges.

FIG. 23A depicts a perspective view of another variable-length support in a collapsed configuration for locating the apparatus at a first distance relative to a back surface of the body.

FIG. 23B depicts a perspective view of the FIG. 23A support in an extended configuration for locating the apparatus at a second distance relative to the back surface.

FIG. 23C depicts a perspective view of a fixed-length support for locating the apparatus at the first distance.

FIG. 23D depicts a perspective view of another fixed-length support for locating the apparatus at the second distance.

FIG. 24 depicts a perspective, exploded view of another exemplary system comprising illustrative examples of a lid, a body, an apparatus, and supports.

FIG. 25 depicts a perspective, exploded view of the FIG. 24 system.

FIG. 26 depicts a perspective, assembled view of the FIG. 24 system.

### DETAILED DESCRIPTION

Aspects of this disclosure are directed to device mounting apparatus, kits, methods, and systems. Numerous exemplary aspects are described. Some aspects are described and/or depicted with reference to particular features, functional capabilities, and/or structures. Unless claimed, these examples are provided for convenience and not intended to limit the present disclosure. Accordingly, any examples described in this disclosure may be utilized with any analogous device mounting apparatus, kits, methods, and systems.

Numerous axes are described herein. Wherever used, the term “non-parallel” means: lying, or being across; set crosswise; or made at right angles to one or more of these axes, including perpendicular and non-perpendicular arrangements. The term “longitudinal” may be used to describe relative components and features. For example, longitudinal may refer to an object having a first dimension or length along an axis that is longer in relation to a second dimension or width along the axis. These terms are provided for convenience and do not limit this disclosure unless claimed.

As used herein, the terms “comprises,” “comprising,” “includes,” “including,” or any other variation thereof, are intended to cover a non-exclusive inclusion, such that an apparatus, method, or element thereof comprising a list of elements does not include only those elements, but may include other elements not expressly listed or inherent the apparatus or method. Unless stated otherwise, the term “exemplary” is used in the sense of “example,” rather than “ideal.” Various terms of approximation may be used in this disclosure, including “approximately” and “generally.” Approximately means within plus or minus 10% of a stated number.

Terms such as “engageable with,” “engaged with,” and “engaging” are used in this disclosure to describe any type of operable and/or structural connection between two or more elements. Such connections may be non-removable, as when the two or more elements are formed together and cannot be separated without damaging them; or removable, as when the elements are joined together by one or more attachment elements (e.g., adhesives, frangible portions, pins, screws, etc.) and can be separated by removing or disrupting the attachment elements. Accordingly, unless stated otherwise, the term engageable and its equivalents may comprise any “non-removably engageable” and “removably engageable” variations.

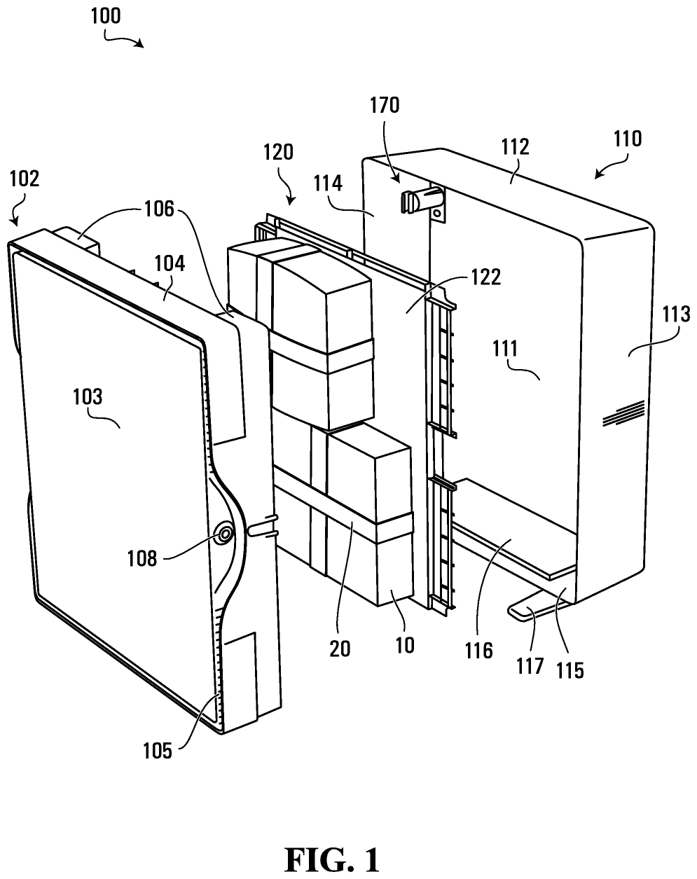

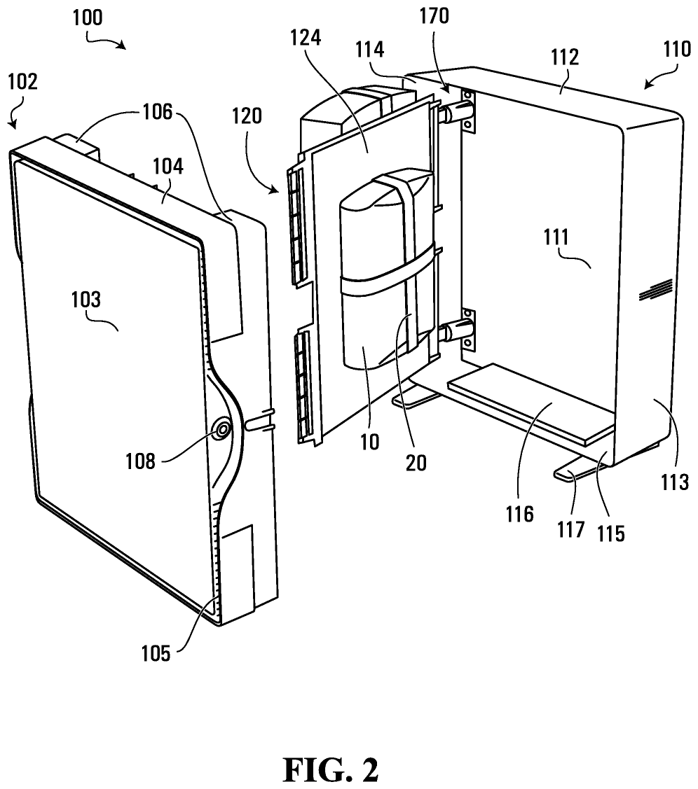

Different series of numbers (e.g., 100 series, 200 series, etc.) may be used to describe different aspects. Wherever possible, similar numbers have be used within each series to describe similar aspects. These distinctions are exemplary, such that any series and/or number may be used without limiting this disclosure. Aspects of this disclosure are now described with reference to an exemplary system 100, followed by descriptions of operational aspects associated therewith. As shown in FIGS. 1 and 2, system 100 may comprise a lid 102, a body 110, an apparatus 120, and hinges 170.

Any objects 10 may be secured to apparatus 120 with one or more attachment elements 20. For example, as shown in FIGS. 1 and 2, a first set of objects 10 may be secured to a front side 122 of apparatus 120 (FIG. 1) with a first set of attachment elements 20 and/or a second set of objects 10 may be secured to a back side 124 of apparatus 120 (FIG. 2) with a second set of attachment elements 20. Objects 10 may comprise any electronic equipment configured to perform functions by sending and receiving electronic signals (e.g., wireless hubs and routers). To protect the electronic equipment against the elements without sacrificing performance, each element of system 100 may be composed of a polymeric material that is transparent to the electronic signals, such as a radio-translucent plastic, like polyethylene.

As shown in FIGS. 1 and 2, lid 102 may comprise a panel 103, a frame 104, venting 105, a flange 106, and a lock 108. Elements of lid 102 may be formed together via a moulding or printing process such that: (i) frame 104 comprises an opening sized to receive panel 103; (ii) venting 105 is located between panel 103 and frame 104; and (iii) flange 106 extends outwardly from frame 104 for receipt in an interior cavity of body 110. Lock 108 may comprise any mechanism for securing lid 102 on body 110, such as a barrel lock with a paddle that is movable with a key between an unlocked configuration where the paddle is not engaged with body 110 and a locked configuration where the paddle is engaged with body 110.

Body 110 may comprise any type of box, enclosure, receptacle, or structure having one or more surfaces engageable with lid 102 and/or hinges 170 using any type of attachment means. For example, numerous aspects are described with reference to body 110 as a receptacle comprising one or more surfaces defining an interior cavity, such as a fuse box or its equivalent, although any type of box, enclosure, or structure may be used without departing from this disclosure. As shown in FIGS. 1 and 2, the one or more surfaces of body 110 may comprise a back surface 111, a top surface 112, a first side surface 113, a second side surface 114, and a bottom surface 115.

Each element of body 110 may be formed together via a moulding or printing process such that surfaces 111-115 form an interior cavity sized to receive apparatus 120 and objects 10 and a front opening sized to receive flange 106 of lid 102. For example, lid 102 and body 110 may be configured so that apparatus 120 and any objects 10 secured thereto may be sealed in the interior cavity when flange 106 is received in the opening. Venting 105 may promote a circulation of air inside of the interior cavity that helps to maintain objects 10 at a desired temperature. Lock 108 may be operable secure lid 102 onto body 110 to protect objects 10. Body 110 of FIG. 1 may comprise numerous additional features, including a raised structure 116, one or more feet 117, and/or plurality of supports 474 described below.

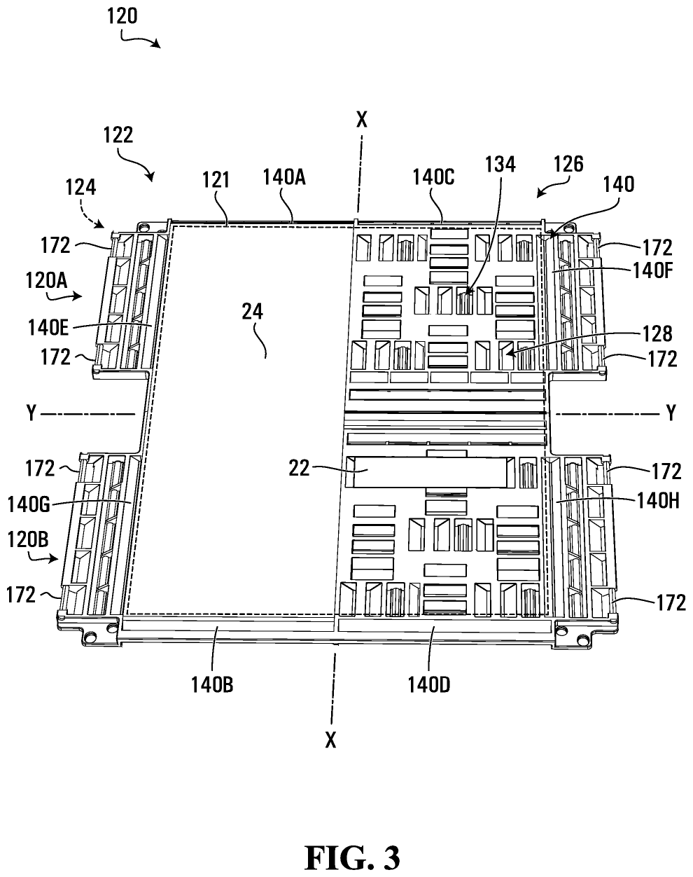

Apparatus 120 may comprise one or more structures engageable with one or more attachment elements 20 to secure objects 10 thereto. As shown in FIGS. 1 and 2, apparatus 120 may comprise any plate or plate-like structure engageable with body 110, including any structure sized for receipt within the interior cavity of body 110. For example, much like back surface 111 of body 110, portions of apparatus 120 may be planar or generally planar, allowing them to be offset uniformly from surface 111. Aspects of apparatus 120 are now described with reference to FIG. 3, which depicts one apparatus 120 comprising front side 122, back side 124, a plurality of securing slots 126, and a plurality of connectors 172. As shown, each securing slot 126 may extend through side front side 122 and back side 124 and/or comprise various surfaces engageable with one or more attachment elements 20.

Different sets of plurality of securing slots 126 may be located and/or configured for different purposes, such as engaging with different sets of attachment elements 20. As shown in FIG. 3, plurality of securing slots 126 may comprise: (i) a first set of securing slots 128 located on an interior portion 121 of apparatus 120 and configured to secure objects 10 to front side 122; (ii) a second set of securing slots 134 located on interior portion 121 of apparatus 120 and configured to secure objects to back side 124; and (iii) a third set of securing slots 140 located adjacent (e.g., on a perimeter of) interior portion 121 and configured to secure objects 10 to front side 122 or back side 124. Attachment elements 20 may comprise any number of tensioning elements operable with securing slots 128, 134, and 140 to secure objects 10 to front side 122 or back side 124. Each tensioning element may be a Velcro strap or its equivalent. As shown in FIG. 3, for example, attachment elements 20 may comprise a first, narrower attachment element 22 for use with securing slots 128 and 134 and a second, comparatively wider attachment element 24 for use with securing slots 140.

Apparatus 120 may comprise a plurality of connectors 172. As shown in FIG. 3, apparatus 120 may comprise a plurality of corner positions (e.g., at least four), and each corner position may comprise: (i) at least one connector 172; and/or (ii) one or more holes configured to receive an attachment element (e.g., a pin) engageable with back surface 111 or another surface to secure apparatus 120 thereto

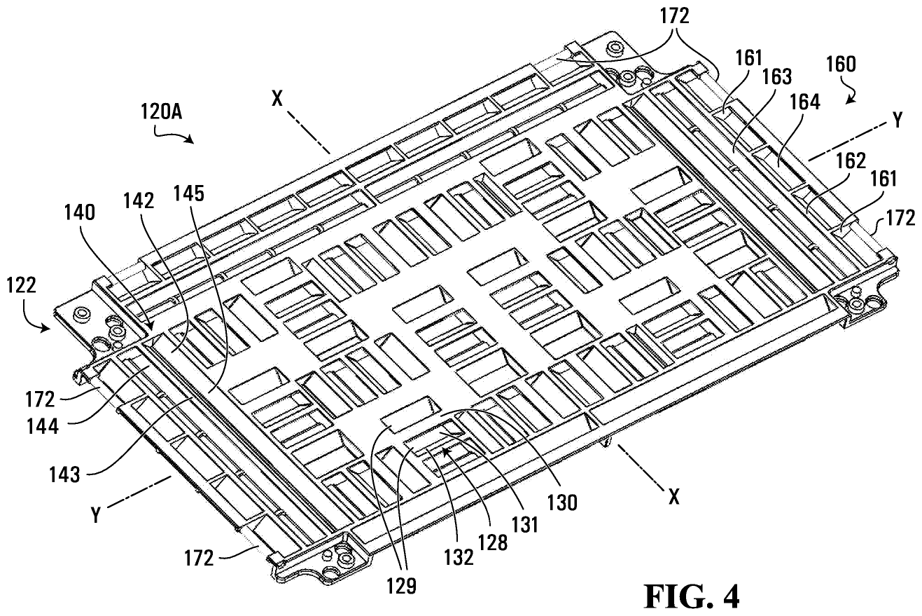

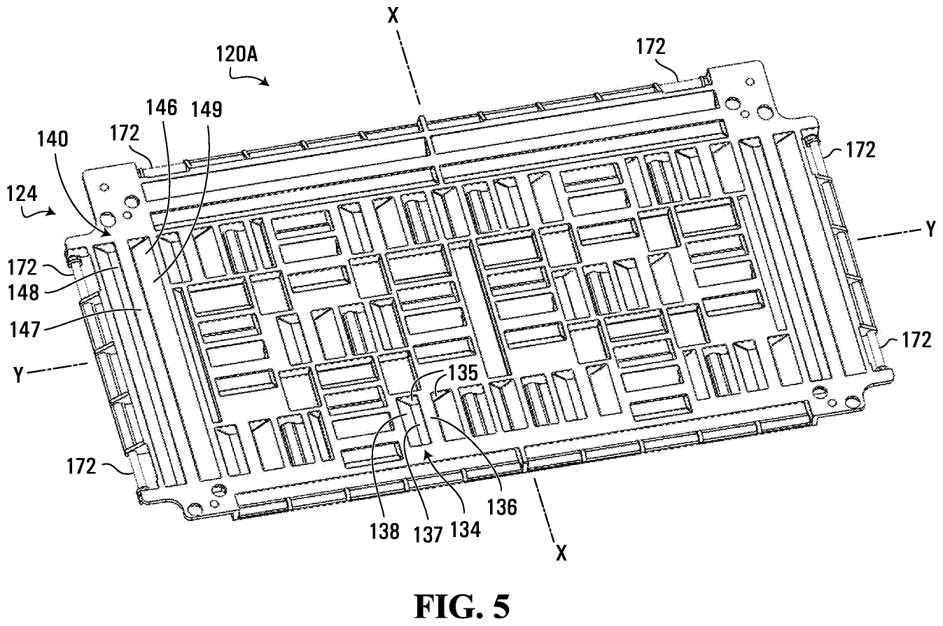

Apparatus 120 may comprise separate apparatus portions that are removable and/or joinable to accommodate different objects 10 and/or bodies 110 having different sizes. As shown in FIGS. 4 and 5, apparatus 120 may be split into an apparatus portion 120A and an apparatus portion 120B. Aspects of apparatus portion 120A may be similar or identical to aspects of apparatus portion 120B, such as slots 128, 134, and 140. For example, each apparatus portion 120A and 120B may similarly comprise four corner positions, and each corner portion may similarly comprise similar holes and connectors 172. Any aspects of apparatus 120, 120A, and 120B may be interchangeable according to the examples described herein.

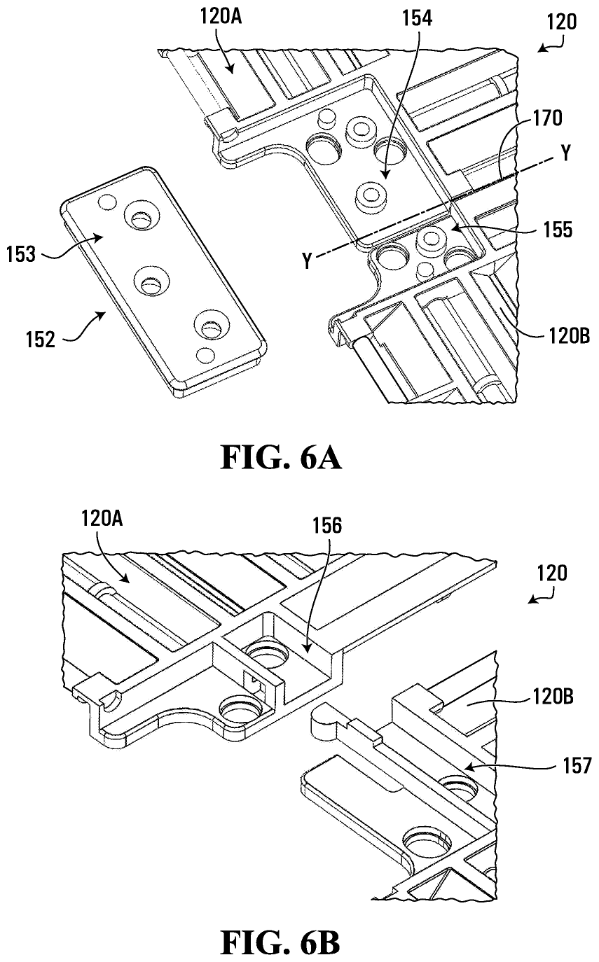

As shown in FIG. 3, apparatus portion 120A may be split from apparatus portion 120B along a first (e.g., horizontal) axis Y-Y. A frangible or cuttable portion of apparatus 120 may extend along first axis Y-Y, allowing apparatus portion 120A to be split from apparatus portion 120B without specialized tools. As shown in FIG. 6A, a connecting structure 152 may be used to engage apparatus portion 120A with apparatus portion 120B. For example, apparatus portion 120A may comprise holes 154 adjacent axis Y-Y, apparatus portion 120B may comprise holes 155 adjacent the axis, and connecting structure 152 may comprise holes 153 alignable with holes 154 and 155 to engage apparatus portion 120A with apparatus portion 120B via attachment elements (e.g., a screw). Other attachment elements may be used. As shown in FIG. 6B, apparatus portion 120A also may comprise an interlocking structure 156 and apparatus portion 120B may comprise an interlocking structure 157 operable with interlocking structure 156 to engage apparatus portion 120A with apparatus portion 120B.

Aspects of first and second securing slots 128 and 134 are now described with reference to first apparatus portion 120A, although similar aspects also may be described with respect to apparatus portion 120B, apparatus 120, and/or any other apparatus described herein. As shown in FIGS. 4 and 5, first securing slots 128 may be similar to second securing slots 134. For example, each first slot 128 may comprise openings 129 and bar-structures 130 (e.g., FIG. 4) interweavable with one or more attachment elements 20 to secure objects 10 to front side 122; and each second slot 134 may comprise openings 135 and bar-structures 136 (e.g., FIG. 5) interweavable with one or more attachment elements 20 to secure objects 10 to back side 124. Openings 129 and bar-structures 130 may be mirror opposites of openings 135 and bar-structures 136.

Openings 129 of first securing slots 128 may comprise different shapes and/or orientations configured to promote flexible uses of attachment elements 20. As shown in FIG. 4, openings 129 may be located on opposite sides of bar-structures 130 and extend through front side 122. A front of each bar-structure 130 may be flush with front side 122. Each first securing slot 128 may comprise a back opening 131 extending through back side 124 under bar-structure 130, and surfaces 132 extending diagonally between outer edges of front openings 129 and outer edges of back opening 131, defining a trapezoidal interior cavity for attachment elements 20. As also shown in FIG. 4, some slots 128 may be aligned with a first (e.g., horizontal) axis Y-Y of first apparatus portion 120A and some slots 128 may be aligned with a second (e.g., vertical) axis X-X of apparatus portion 120B.

Openings 135 of second securing slots 134 also may comprise different shapes and/or orientations configured to promote flexible uses of attachment elements 20. As shown in FIG. 5, openings 135 may be located on opposite sides of bar-structures 136 and extend through back side 124. A front of each bar-structure 136 may be flush with back side 124. Each second securing slot 134 also may comprise a back opening 137 extending through back side 124 under bar-structure 136, and surfaces 138 extending diagonally between outer edges of openings 129 and outer edges of back opening 137, defining another trapezoidal interior cavity for attachment elements 20. As also shown in FIG. 5, some slots 134 may be aligned with first axis Y-Y of first apparatus portion 120A and some slots 134 may be aligned with second axis X-X of apparatus portion 120B.

As shown in FIG. 3, each third securing slot 140 may extend along any perimeter of apparatus 120, including all or a substantial part of any sides of interior portion 121. One or more of the third securing slots 140 may be located on opposite sides of interior portion 121. For example, third securing slots 140 of FIG. 3 may comprise: a first slot 140A disposed opposite of a second slot 140B; a third slot 140C opposite of a fourth slot 140D; a fifth slot 140E opposite of a sixth slot 140F; and/or a seventh slot 140G opposite of an eighth slot 140H. Each third securing slot 140 may be operable with wider attachment element 24. As shown in FIG. 3, attachment element 24 may cover approximately one-half of interior portion 121 and be secured by and tensioned between opposing slots 140A and 140B.

Aspects of third securing slots 140 are now described with reference to first apparatus portion 120A. As shown in FIG. 4, each third securing slot 140 may comprise an opening 142 extending through front side 122 at a location adjacent interior portion 121, an opening 144 extending through back side 124 at a location spaced apart from interior portion 121, and a surface 145 extending diagonally between outer edges of opening 142 and outer edges of opening 144. Each slot 140 also may comprise a bar-structure 143 and openings 142 on each side of bar-structure 143; and/or additional surfaces defining interior cavities of apparatus portion 120A (e.g., such as an additional trapezoidal cavity).

As shown in FIG. 5, each third securing slot 140 also may comprise an opening 146 extending through back side 124 at a location adjacent interior portion 121, an opening 148 extending through front side 122 at a location spaced apart from interior portion 121, and a surface 149 extending diagonally between outer edges of opening 146 and outer edges of opening 148. Each slot 140 may similarly comprise a bar-structure 147 and openings 146 on each side of bar-structure 147; and/or additional surfaces defining interior cavities of apparatus portion 120A (e.g., such as an additional trapezoidal cavity). As also shown in FIGS. 4 and 5, slots 140 may be aligned with axis X-X or Y-Y of first apparatus portion 120A.

As described in system 100, body 110 may comprise (e.g., be engageable with) a plurality of supports 174; apparatus 120 may comprise a plurality of connectors 172; and each connector 172 of plurality of connectors 172 may be engageable with a respective support 174 of plurality of supports 174, wherein, when any one connector 172 of plurality of connectors 172 is engaged with its respective support 174 of plurality of supports 174, a hinge 170 associated with the one connector 172 permits movement of apparatus 120 relative to body 110 about at least one axis of rotation for hinge 170.

Hinge 170 may be formed when one connector 172 is engaged with its respective support 174. As shown in FIGS. 3, 4, and 5, plurality of connectors 172 may be spaced apart around a perimeter of interior portion 121. For example, apparatus 120 may comprise multiple (e.g., four) corner positions and one connector 172 located at each corner position (e.g., four in total); and each connector 172 may be located opposite of another connector 172 along an axis extending through apparatus 120 (e.g., an axis parallel to axis X-X or Y-Y).

To provide flexibility during installation, apparatus 120 may comprise additional connectors 172. For example, apparatus 120 may comprise additional connectors 172 on each side of axis Y-Y so that apparatus portion 120A and 120B may have one connector 172 at each of their corner positions when apparatus 120 is split apart. To provide further flexibility, apparatus 120 may comprise fourth securing slots 160 spaced apart between each connector 172. As shown in FIG. 4, each fourth securing slot 160 may comprise arms 161 extending outwardly from a surface 162 extending diagonally between back openings 163 and front openings 164. Additional connectors 172 may be located relative to slots 160.

As described herein, any hinge 170 may comprise either: (i) a single axis hinge, in which connector 172 is movable relative to support 174 about at least one rotational axis; or (ii) a multi-axis hinge, in which connector 172 is movable relative to support 174 about a plurality of different rotational axes. Hinges 170 of system 100 provide one example of single axis hinges. Aspects of exemplary multi-axis hinges are described below with respect to hinges 470 and 870.

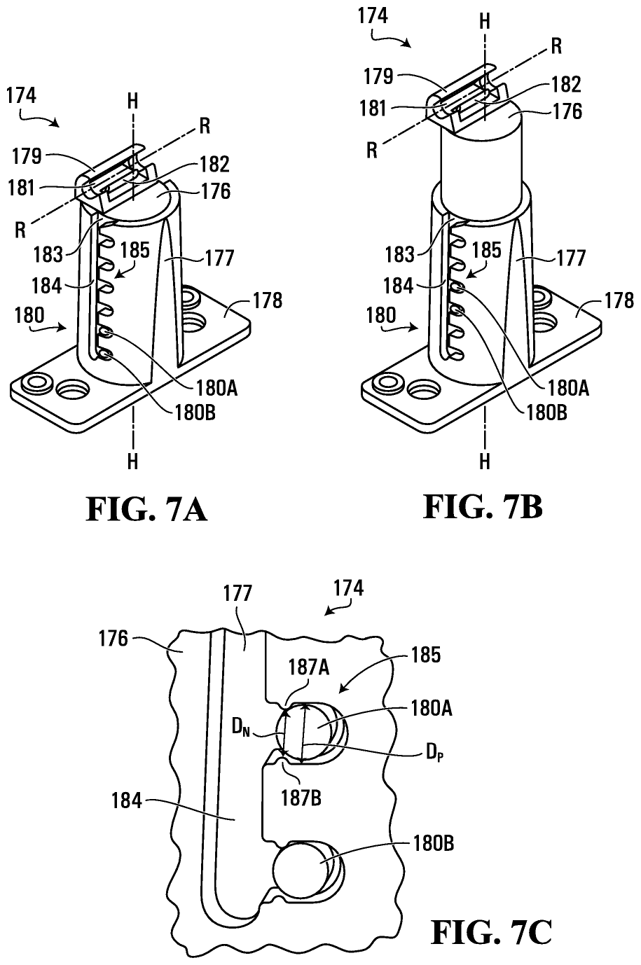

Aspects of hinge 170 are now described with reference to FIGS. 7A and 7B, which depict support 174 as being linearly expandable along a hinge axis H-H between a collapsed configuration (e.g., FIG. 7A) and an extended configuration (e.g., FIG. 7B). As shown, support 174 may comprise a movable support body 176, a fixed support body 177, and a support base 178. As shown in FIGS. 7A and 7B, movable support body 176 may comprise a first end disposed opposite of a second along hinge axis H-H. A grasper 179 may be located at the first and engageable with connector 17. Movable support body 176 may be configured for selective movement relative to fixed support body 177 along hinge axis H-H. For example, a maintaining element 180 may be located at the second end of moveable support body 176 and engageable with fixed support body 177 to maintain the collapsed and expanded configurations. In this example, maintaining element 180 may comprise any structures configured to maintain the one or more positions of movable support body 176 relative to fixed support body 177, such as pins 180A and 180B of FIGS. 7A and 7B.

Grasper 179 may comprise any structures for securing connector 172 to support 174 and allowing for rotation of connector 172 relative to support 174 about one or more axes. As shown in FIGS. 7A and 7B, interior surfaces of grasper 179 may comprise a channel 181 extending along a rotational axis R-R that is non-parallel with hinge axis H-H. Rotational axis R-R may be offset from hinge axis H-H so that a centerline of channel 181 is offset from hinge axis H-H. As shown in FIGS. 7A and 7B, channel 181 may comprise an opening that is non-parallel with hinge axis H-H and rotational axis R-R to decrease the likelihood that connector 172 is inadvertently disengaged from support 174 when moving apparatus 120.

As shown in FIG. 3, each connector 172 may comprise a connecting rod structure that is receivable in channel 181 for rotation about axis R-R. Each connecting rod structure may be aligned with axis X-X or Y-Y of apparatus 120. Because channel 181 is extends along rotational axis R-R, exterior surfaces of the connecting rod structure may interact with interior surfaces of channel 181 to permit a generally single-axis rotation of the connecting rod in channel 181 about axis X-X or Y-Y. Due to machine tolerances and material limitations, it is likely that rotational axis R-R may comprise a small range of rotational axes approximate thereto (e.g., approximately 5°) without departing from the single axis nature of the rotation. As further shown in FIGS. 7A and 7B, grasper 179 may comprise a retaining element 182 that is rotatably mounted in an entry portion of channel 181, movable relative to channel 181 to permit entry of the connecting rod structure into channel 181, and/or resiliently configured to maintain the rod structure in channel 181.

Fixed support body 177 may extend outwardly from support base 178 along hinge axis H-H to define a channel 183. For example, channel 183 may comprise a cylindrical or tubular shape extending outwardly from support base 178 along hinge axis H-H. Movable support body 176 may be receivable in channel 183 for movement along and/or rotation relative to hinge axis H-H. For example, movable support body 176 may comprise a circular shape that is slidably and rotatably receivable in the cylindrical or tubular shape of channel 183.

As shown in FIGS. 7A and 7B, a side surface of fixed support body 177 may comprise a slot track 184 extending into channel 183. Slot track 184 may comprise with one or more notches 185 corresponding with the one or more positions of movable support body 176 relative to fixed support body 177. Maintaining element 180 may be engageable with slot track 184 and notches 185. For example, notches 185 may comprise a plurality of notches; maintaining element 180 may comprise one or more pins, such as pins 180A and 180B; and the one or more pins may be engageable with any two notches of the plurality of notches at each of the one or more positions of movable support body 176 relative to fixed support body 177.

Accordingly, support 174 may be switchable between the one or more positions by: (i) rotating movable support body 176 relative to fixed support body 177 about hinge axis H-H to disengage pins 180A, B from a first set of notches 185; (ii) moving movable support body 176 relative to fixed support body 177 along hinge axis H-H to move pins 180A, B away from the first set of notches 185 and toward a second set of notches 185; and (iii) rotating movable support body 176 relative to fixed support body 177 about hinge axis H-H to engage pins 180A, B with the second set of notches 185.

Support base 178 may be engageable with any surface of body 110. For example, support base 178 may comprise one or more holes operable with an attachment element (e.g., a pin or a screw) to engage support base 178 with back surface 111 of body 110. As shown in FIGS. 7A and 7B, support base 178 may comprise a planar portion that is engageable with a corresponding planar portion of back surface 111 to orient and maintain hinge axis H-H at a generally perpendicular angle with respect to back surface 111 and/or maintain rotational axis R-R a generally parallel angle with respect to surface 111 when support base 178 is engaged therewith.

As shown in FIG. 7C, any notch 185 may comprise a retaining structure 186 engageable with maintaining element 180 to maintain the one or more positions of movable support body 176 relative to fixed support body 177. Retaining structure 186 may comprise a nub 187 extending outwardly from a side surface of the notch 185. As shown, nub 187 may comprise a first semi-circular nub 187A on a first side surface of the notch and a second semi-circular nub 187B on a second side surface of the notch 185. First semi-circular nub 187A may be disposed opposite of second semi-circular nub 187B. For example, each pin 180A and 180B may comprise a circular shape with a pin diameter Dₚ. As shown in FIG. 7C, a nub spacing distance Dₙ between first semi-circular nub 187A and second semi-circular nub 187B may be less than pin diameter Dₚ. For example, fixed support body 177 may be composed of a resilient material that flexes to expand nub spacing distance Dₙ, allowing the larger diameter Dₚ of pins 180A or 180B to pass from an entry portion of notch 185, between nubs 187A and 187B, and into an end portion of notch 185. In this example, the resilient material may rebound to retain pins 180A or 180B in the end portion of notch 185 after passing between nubs 187A and 187B.

As described herein, any hinge 170 may comprise a variable-length hinge, in which connector 172 is movable relative to support 174 along hinge axis H-H; or a fixed-length hinge, in which connector 172 is fixed relative to support 174 along hinge axis H-H. As noted above, one variable-length example is provided by the interaction of movable support body 176 and fixed support body 177 of FIGS. 7A-C, in which hinge 170 is linearly expandable between one or more positions, including the collapsed configuration of FIG. 7A and the extended configuration of FIG. 7B.

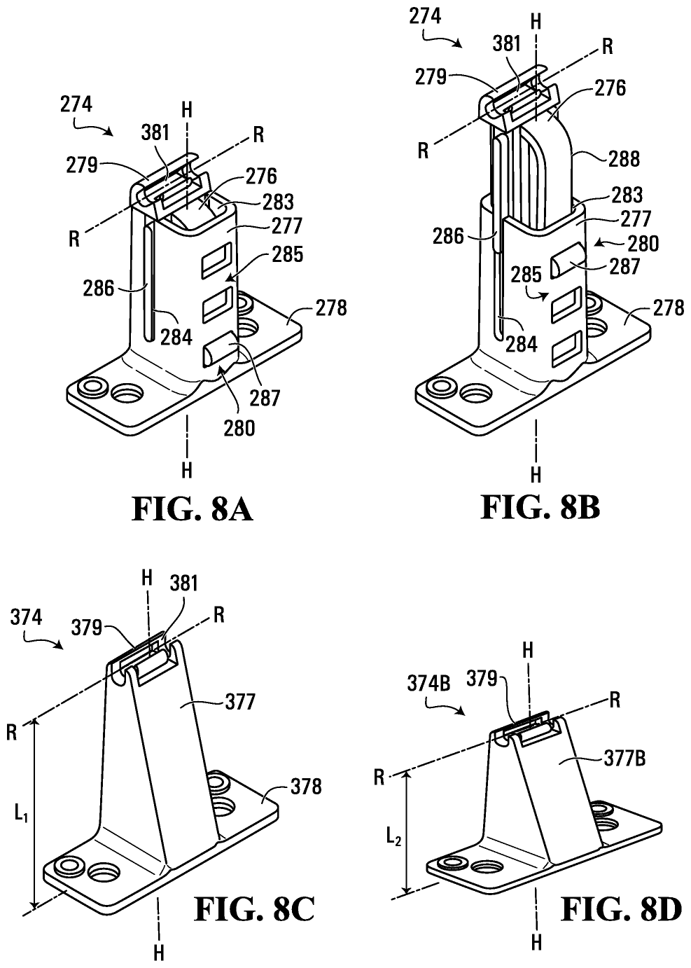

Another variable-length example is now described with reference to FIGS. 8A and 8B, which depict a support 274. Aspects of support 274 may be similar to aspects of support 174, but within the 200 series of numbers. As shown in FIG. 8A, support 274 may similarly comprise a movable support body 276, a fixed support body 277, and a support base 278. Movable support body 276 may be configured for selective movement relative to fixed support body 277 about a hinge axis H-H, allowing hinge 170 to be linearly expandable between one or more positions along axis H-H, including a collapsed configuration shown in FIG. 8A and an extended configuration shown in FIG. 8B. In keeping with previous examples, movable support body 276 may comprise a first end disposed opposite of a second along hinge axis H-H. A grasper 279 may be located at the first and engageable with connector 172. A maintaining element 280 may be located at the second end and engageable with fixed support body 277.

Grasper 279 may comprise any structures for securing connector 172 to support 274 and allowing for rotation of connector 172 relative to support 274 about one or more axes. As shown in FIGS. 8A and 8B, interior surfaces of grasper 279 may similarly comprise a channel 281 extending along a rotational axis R-R that is non-parallel with hinge axis H-H and opens similar to channel 181. As above, fixed support body 277 may extend outwardly from support base 278 along hinge axis H-H to define a channel 283. In contrast to above, channel 283 may comprise a rectangular or tubular shape extending outwardly from support base 278 along hinge axis H-H; and movable support body 276 may be slidably receivable in the rectangular or tubular shape without any substantial rotation.

Maintaining element 280 may function similarly to maintaining element 180. As shown in FIGS. 8A and 8B, a first side surface of fixed support body 277 may comprise a slot track 284 extending into channel 283, and a second side surface of fixed support body 277 may comprise a plurality of openings 285. At least one side of movable support body 277 may comprise a first protrusion 286 engageable with slot track 284 to guide movements of body 277 relative to body 276 along hinge axis H-H. A first end of movable support body 277 may comprise a second protrusion 287 engageable with openings 285 to switch between and maintain the one or more positions. Second protrusion 287 may be biased outwardly from the first end of the movable support body 276 and configured to snap into each opening of plurality of openings 285 when body 277 moves relative to body 276. As shown in FIG. 8D, movable support body 276 may comprise a biasing portion 288 that is cantilevered from the second end of body 276. As also shown in FIGS. 8A and 8B, second protrusion 287 may be on or adjacent a terminal end of biasing portion 288, which may be curved to apply a biasing force to second protrusion 287, and exterior surfaces of second protrusion 287 may be curved for entry to and exit from openings 285.

Fixed-length examples of hinges 170 are now described with reference to support 374 of FIG. 8C. Aspects of support 374 may be similar to aspects of supports 174 and 274, but within the 300 series of numbers, except that support 374 may not be linearly expandable. For example, support 374 may similarly comprise a support body 377 and a support base 378. In keeping with previous examples, support body 377 may comprise a first end disposed opposite of a second along hinge axis H-H, except that body 377 may be configured (i.e., not linearly expandable) to fix a length between its first and second ends. A grasper 379 may be located at the first end and engageable with connector 172 and similar to grasper 279, except that grasper 379 may comprise a channel 381 that opens in a direction parallel with hinge axis H-H. Support base 378 may be located at the second end and engageable with back surface 111.

To match the flexibility provided by adjustable supports 174 and 274, system 100 may comprise a plurality of different supports 374, each having a different length along hinge axis H-H. For example, system 100 may comprise at least four of supports 374 of FIG. 8C and at least four of a supports 374B of FIG. 8D. Fixed support body 377 may comprise a first length L₁ configured to located apparatus 120 at a first distance from back surface 111. Second support 374B of FIG. 8D may be similar to support 374 of FIG. 8C, but with a fixed body 377B comprising a second length L₂ configured to locate apparatus 120 at a second distance from back surface 111 that is different from the second distance (e.g., shorter).

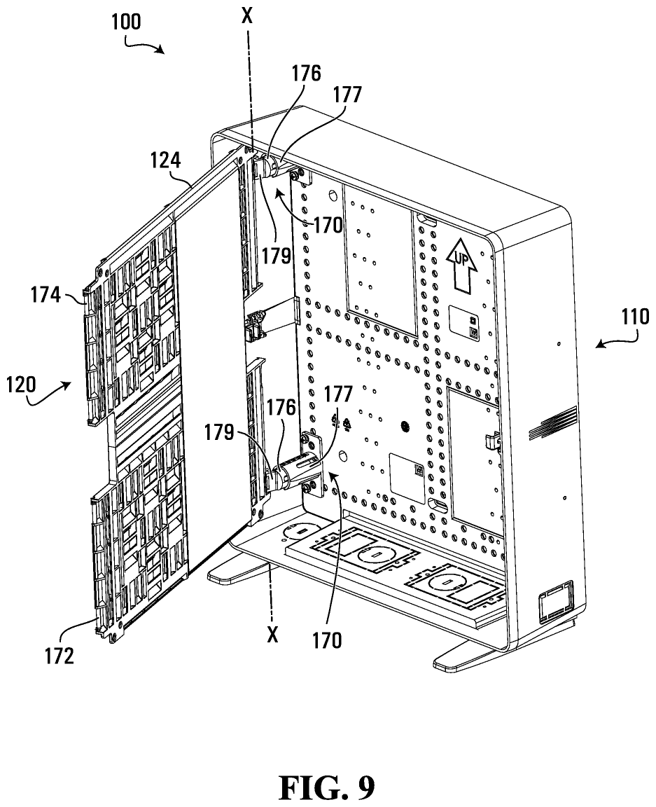

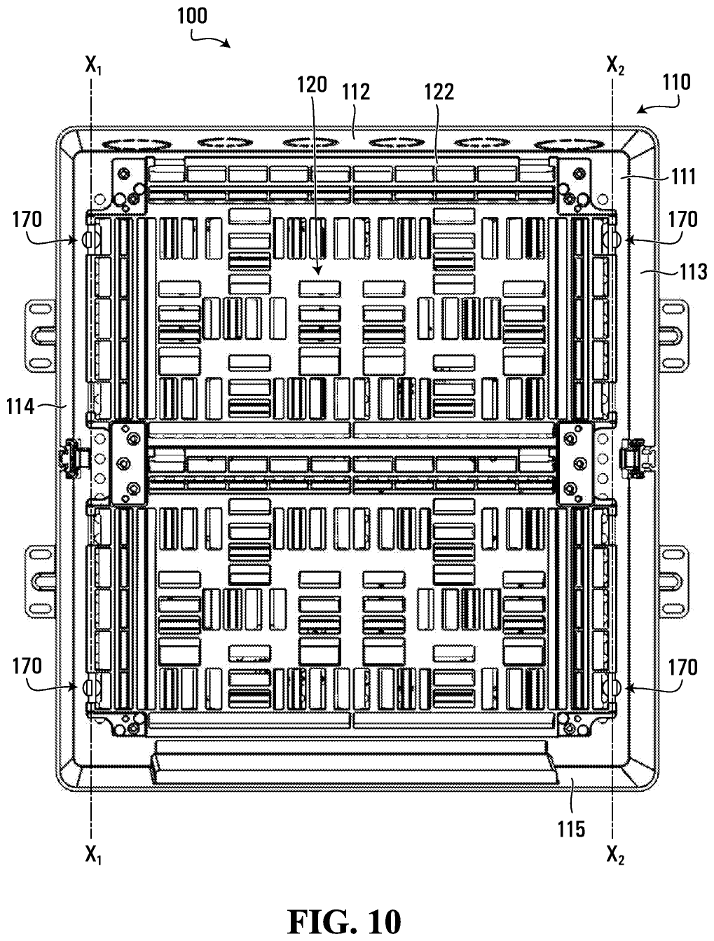

Operational aspects of system 100 are now described with reference to FIG. 9, which depicts apparatus 120 as being rotated relative to body 110; and FIG. 10, which depicts apparatus 120 as being fixed relative to body 110.

As shown in FIG. 9, plurality of hinges 170 may comprise: (i) a set of supports 174 (e.g., at least two) engaged with back surface 111 so that their respective rotational axis R-R are aligned along a first (e.g., vertical) axis X-X of body 110; and (ii) a corresponding set of connectors 172 (e.g., at least two) engaged with the set of supports 174 so that apparatus 120 is movable about axis X-X relative to back surface 111. As described herein, each support 174 may be configured to maintain a distance between back side 124 and back surface 111. For example, each support 174 of FIG. 9 is shown in the collapsed of position of FIG. 7A and thus configured to maintain a first distance between back side 124 and back surface 111, but alternatively may be shown in the extended configuration of FIG. 7B and thus configured to maintain a second distance between back side 124 and back surface 111 that is different from (e.g., longer) than the first distance.

As shown in FIG. 10, plurality of hinges 170 also may comprise: (iii) two sets of supports 174 (e.g., at least two) engaged with back surface 111 so that their respective rotational axis R-R are spaced apart from one another on different vertical axis X1-X1 and X2-X2 of body 110; and (iv) a corresponding set of connectors (e.g., at least two) 172 engaged with the set of supports 174 so that apparatus 120 is not movable about either axis X1-X1 and X2-X2 relative to back surface 111. A set of four supports 174 are shown in FIG. 10 as being engaged with a corresponding set of four connectors 172, one at each corner position of back surface 111 and apparatus 120. In this example, different hinges 170 may rotate apparatus 120 about either axis X1-X1 and X2-X2 relative to back surface 111 to provide flexibility during installation of system 100.

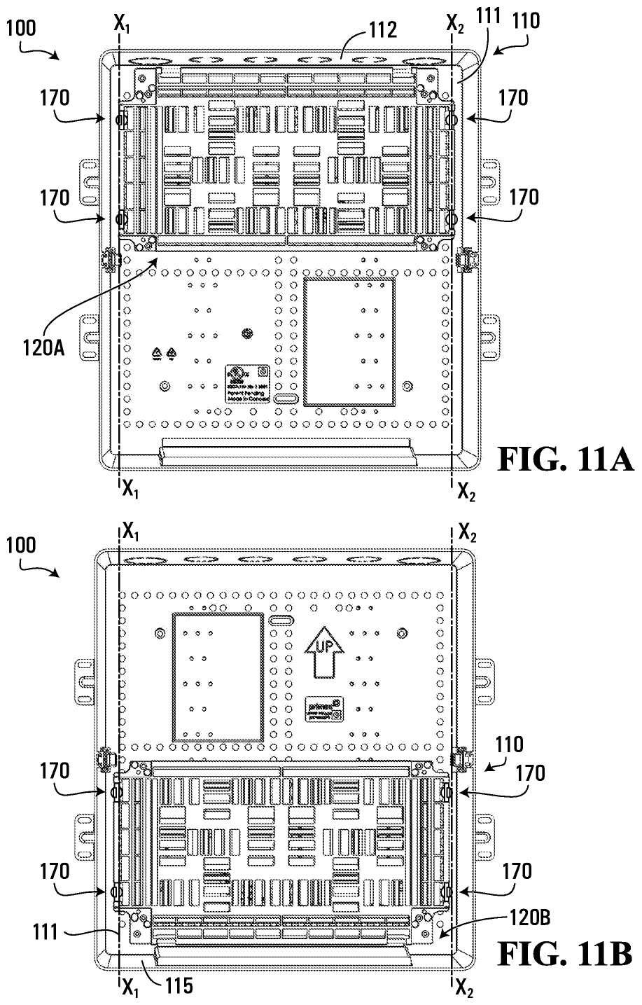

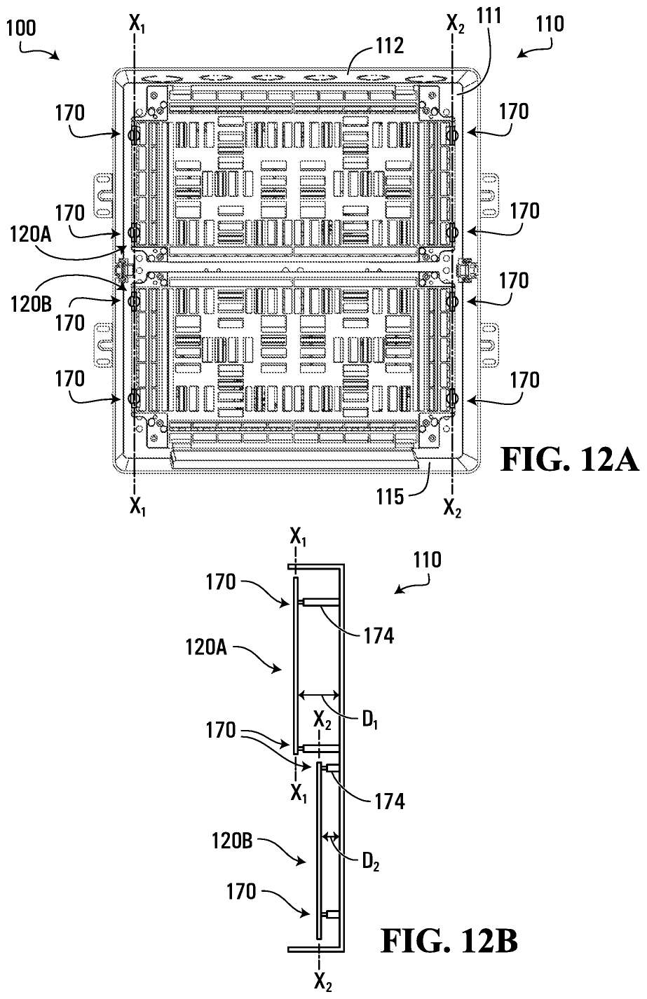

Additional operational aspects of system 100 are now described with reference to FIGS. 11A, 11B, 12A, and 12B, each which depicts different configurations of apparatus 120 after being split into apparatus portion 120A and 120B. As shown, each apparatus portion 120A and/or 120B may comprise four corner positions and one hinge 170 may be formed at each corner position. For example, each corner position may comprise one connector 172; and body 110 may comprise four supports 174 engaged with back surface 111 in an arrangement corresponding with the four corner positions, allowing four hinges 170 to be formed by engaging the four connectors 172 with the four supports 174. The arrangement of supports 174 may be located anywhere on back surface 111, allowing apparatus portion 120A and/or 120B to be moved within body 110 to accommodate different objects 10. For example, the four supports 174 may be located in a top portion of body 110 so as to locate first apparatus portion 120A adjacent top surface 112, as in FIG. 11A; or in a bottom portion of body 110 so as to locate second apparatus portion 120B adjacent bottom surface 115, as in FIG. 11B.

Multiple apparatus 120 may be mounted in body 110 with hinges 170. As shown in FIG. 12A, each apparatus portion 120A and/or 120B may comprise different sets of four corner positions and one hinge 170 may be formed at each corner position. For example, each different corner position may comprise one connector 172; and body 110 may comprise eight supports 174 engaged with back surface 111 in an arrangement corresponding with the different sets of four corner positions. In this example, eight hinges 170 may be formed by engaging the eight connectors 172 with eight four supports 174. Any number of hinges 170 may be similarly formed.

As described above, each hinge 170 may be linearly expandable along its respective hinge axis H-H, allowing apparatus portion 120A to be maintained differently from apparatus portion 120B. As shown in FIG. 12B, apparatus portion 120A may be rotatably secured in body 110 by a first set of hinges 170 formed by supports 174 in the expanded configuration of FIG. 7A so as to maintain apparatus 120 at a first distance D1 relative to back surface 111; and apparatus portion 120B may be rotatably secured in body 110 by a second set of hinges 170 form by supports 174 in the collapsed configuration of FIG. 7B so as to maintain apparatus portion 120B at a second distance D2 relative to back surface 111 that is different (e.g., shorter) than first distance D1. As shown, a rotational axis X1-X1 of the first set of hinges 170 may be offset from a rotational axis X2-X2 of the second set of hinges 170, allowing apparatus portion 120A to rotate independently from apparatus portion 120B. Similar results may be obtained by forming the first set of hinges 170 with supports 274 in the expanded configuration of FIG. 8A and the second set of hinges 170 with supports 274 in the collapsed configuration of FIG. 8B. Alternatively, the first hinges 170 may be formed with support 374 of FIG. 8C and the second hinges 170 may be formed with support 374B of FIG. 8D, allowing apparatus portion 120A and 120B to be maintained at distances D1 and D2 even if hinges 170 are not linearly expandable.

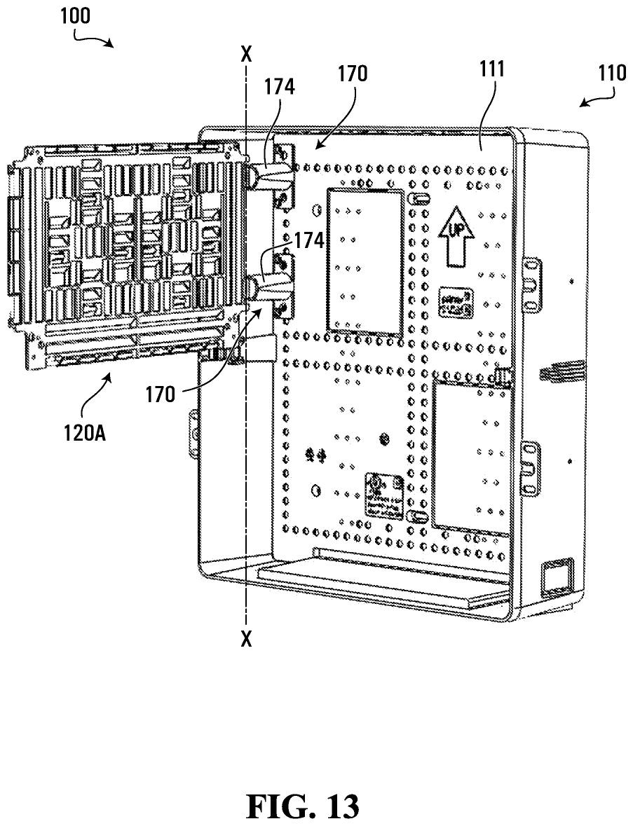

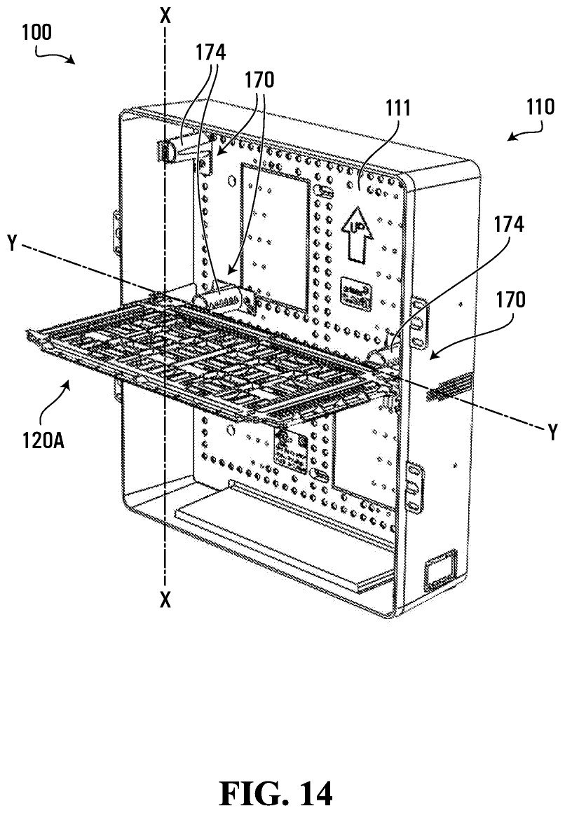

Different hinges 170 may be formed by engaging different sets of connectors 172 with different sets of supports 174 to either prevent rotation of apparatus portion 120A and/or 120B about different axes, as shown in FIGS. 11A, 11B, 12A, and 12B; or permit rotation of apparatus portion 120A and/or 120B about different axes, as shown in FIG. 13. As shown in FIG. 14, an upper set of hinges 170 may comprise a rotational axes R-R aligned with axes X1-X1 and X2-X2 (e.g., as in FIG. 13), and a lower set of hinges 170 may comprise rotational axes R-R aligned with axis Y-Y, allowing apparatus 120 to be rotated about any of axis X1-X1, X2-X2, or Y-Y. AS shown, the lower supports 174 may be engaged differently with back surface 111 (e.g., with different holes) to accommodate different locations of connectors 172.

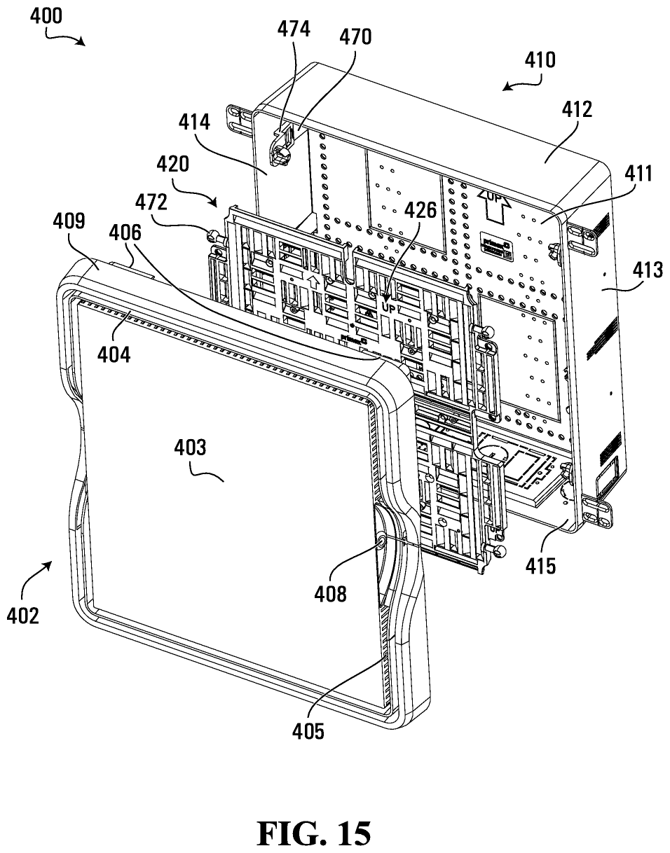

Aspects of this disclosure are now described with reference to an exemplary system 400 shown in FIG. 15 as comprising a lid 402, a body 410, an apparatus 420, and hinges 470. Aspects of system 400 may be similar to counterpart aspects of system 100, but within the 400 series of numbers, any such aspects being interchangeable. Aspects of system 400 are now described, followed by descriptions of operational aspects associated therewith.

As shown in FIG. 15, lid 402 may comprise a panel 403, a frame 404, venting 405, a flange 406, and a lock 408, each of which may be similar to their counterparts in system 100. In contrast to above, lid 402 also may comprise a frame element 409 that is engaged with frame 404 by one or more frangible or cuttable portions, allowing system 400 to be flexibly configured for different installations without specialized tools. As also shown in FIG. 15, body 410 may comprise one or more surfaces similar to their counterparts in system 100, including a back surface 411, a top surface 412, a first side surface 413, a second side surface 414, and a bottom surface 415, each of which may form an interior cavity sized to receive apparatus 420 and a front opening sized to receive flange 406.

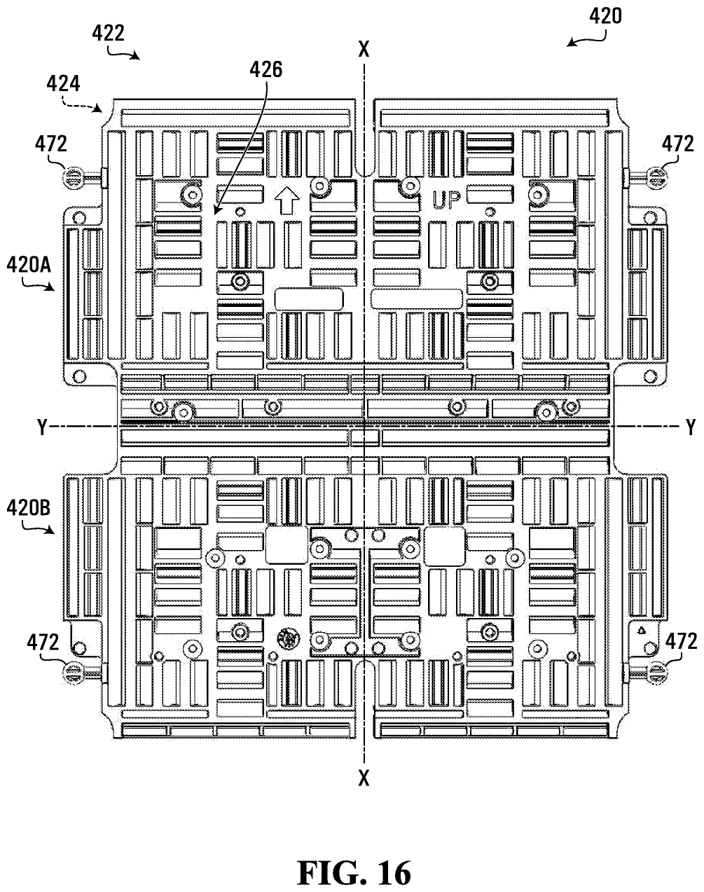

As shown in FIGS. 15 and 16, apparatus 420 may comprise a front side 422, a back side 424, and a plurality of securing slots 426 similar to their counterparts in system 100. For example, each slot 426 may similarly extend through front side 422 and back side 424 and/or comprise surfaces engageable with attachment elements 20, including any surfaces described above with respect to plurality of securing slots 126. As with apparatus 120, apparatus 420 may comprise a plurality of corner positions (e.g., at least four), and each corner position may comprise one or more holes and at least one connector 472. As shown in FIG. 16, apparatus 420 also may comprise separate apparatus portions 420A and 420B that are removable and/or joinable to accommodate different objects 10 having different sizes and/or further enhance the installation flexibility of system 400.

As described in system 400, body 410 may comprise (e.g., be engageable with) a plurality of supports 474, apparatus 420 may comprise a plurality of connectors 472, and each connector 472 of plurality of connectors 472 may be engageable with a respective support 474 of plurality of supports 474, wherein, when any one connector 472 of plurality of connectors 472 is engaged with its respective support 474 of plurality of supports 474, a hinge 470 associated with the one connector 472 permits movement of apparatus 420 relative to body 410 about a plurality of different axes of rotation for hinge 470.

Hinge 470 may be formed when one connector 472 is engaged with its respective support 474. As shown in FIGS. 15 and 16, connectors 472 (e.g., four) may be spaced apart and/or located at corner positions (e.g., four) of apparatus 420; and each connector 472 may be located opposite of another connector 472 along one or more axes extending through apparatus 420. As before, any additional connectors 472 may be located anywhere on apparatus 420.

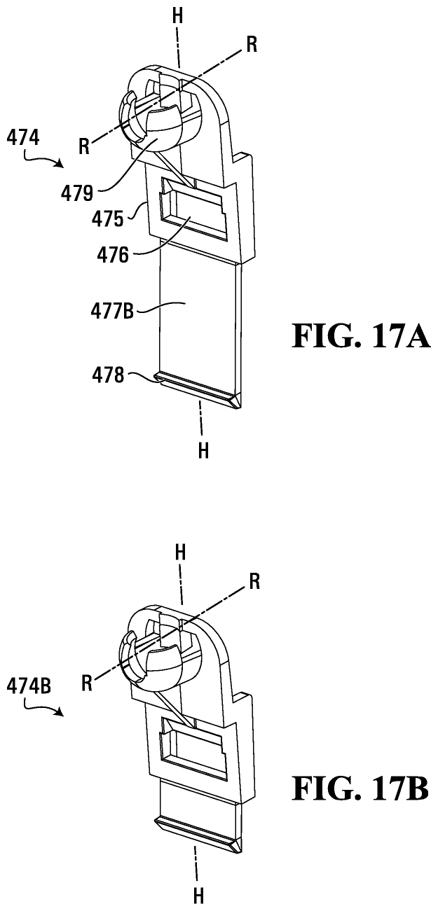

Aspects of hinges 470 are now described with reference to FIG. 17A, which depicts a fixed-length example of supports 474 comprising a support body 475 and a support base 478. In keeping with previous examples, support body 475 may comprise a first end disposed opposite of a second along hinge axis H-H. A grasper 479 may be located at the first end of body 477 and engageable with connector 472. Support base 478 may be located at the second end of body 477 and engageable with back surface 411. In contrast to above, support body 475 may comprise an opening 476 and support base 478 may be located on a support arm 477.

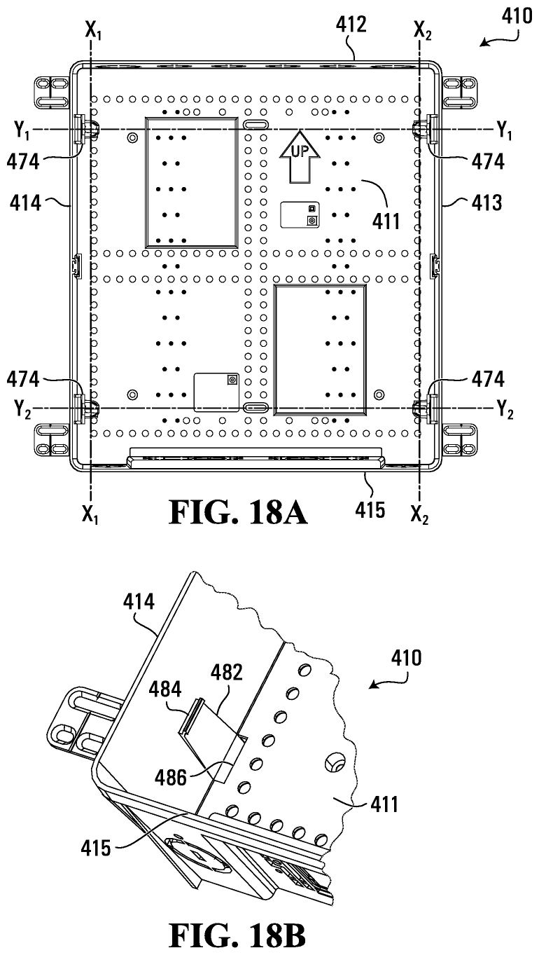

As shown in FIGS. 6A and 6B, support base 178 may be engaged with back surface 111 of body 110, and support body 176 may be spaced apart from side surfaces 113 and 114, without any contact therewith, making support base 178 the only point of contact between support 174 and body 110. Each support 474 may be engaged with back surface 411 and another surface of body 410, such as side surface 413 or 414. As shown in FIGS. 17A and 18B, surfaces of opening 476 may be engageable with a first mounting structure 484 on side surface 413 or 414 and surfaces of support base 478 may be engageable with a second mounting structure 486 on back surface 411, allowing support 474 to be snapped into a fixed position in body 410.

As shown in FIG. 18A, supports 474 (e.g., four) may be spaced apart and/or located at corner positions (e.g., four) of body 410. Each support 474 may be located opposite of another support 474 along one or more axes extending through body 410, including a first (e.g., vertical) axis X1-X1, a second (e.g., vertical) axis X2-X2, a third (e.g., horizontal) axis Y1-Y1, and a fourth (e.g., horizontal) axis Y2-Y2). For example, first axis X1-X1 may be parallel with second axis X2-X2, and second axis Y1-Y1 may be parallel with fourth axis Y2-Y2.

First and second mounting structures 484 and 486 may be located at each corner position. As shown in FIG. 18B, each corner position of body 410 may comprise a support structure 482 with a first end disposed opposite of a second end along hinge axis H-H. Support structure 482 may comprise side surfaces tapering between its first and second ends. First mounting structures 484 may comprise surfaces defining an extension extending outwardly from side surface 414 (or 413) at the first end of support structure 482. Second mounting structures 486 may comprise surfaces defining an opening extending through back surface 411.

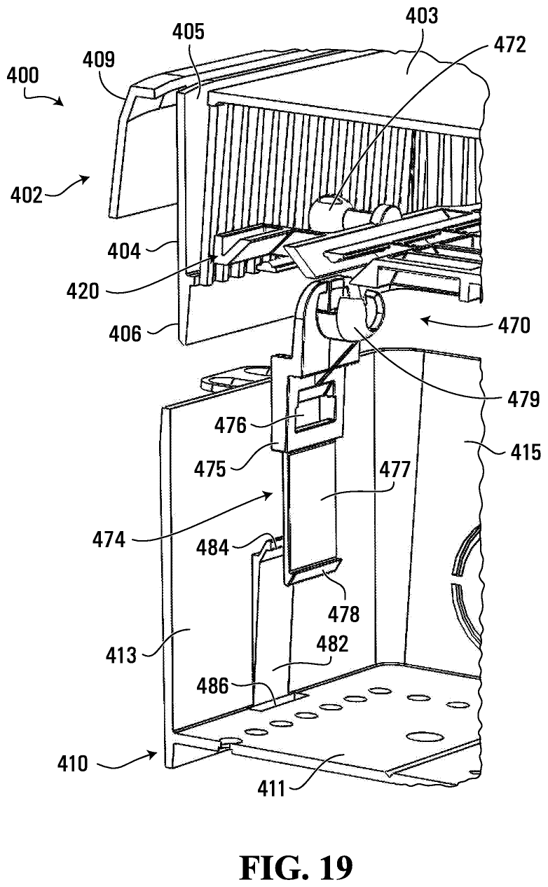

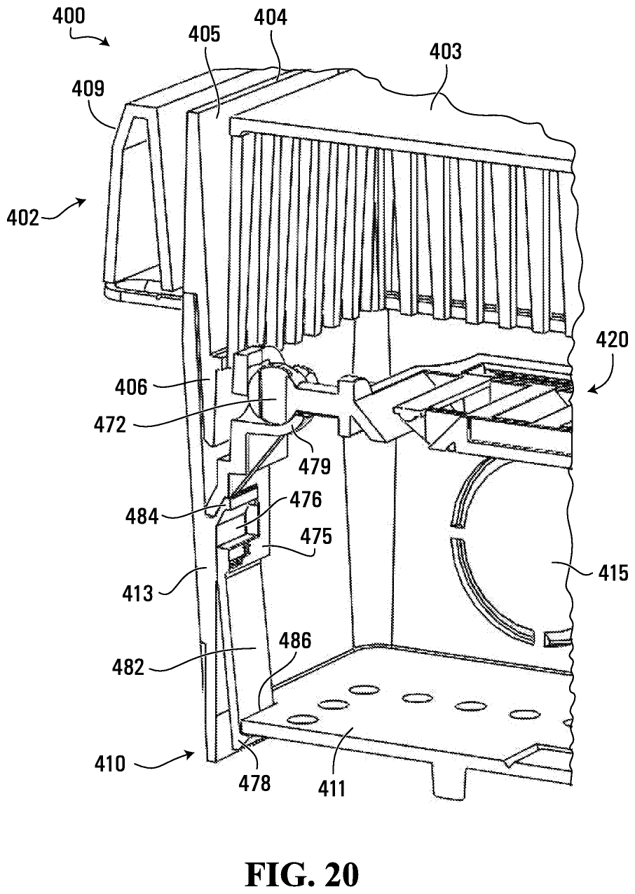

Support 474 may be snapped into the fixed position by tension forces maintained between a first engagement of opening 476 with first mounting structure 484 and a second engagement of support base 478 with second mounting structure 486. As shown in FIG. 19, each support 474 may be aligned with each support structure 482 so that opening 476 is adjacent mounting structure 484 and support base 478 is adjacent mounting structure 486. As shown in FIG. 20, each support 474 may be advanced toward back surface 411 until mounting structure 484 is engaged with opening 476 and mounting structure 486 is engaged with support base 478. For example: (i) the extension of first mounting structure 484 may be received in opening 476 so that forward-facing surfaces of the extension are in contact with backward-facing surfaces of opening 476; and (ii) support base 478 may be passed through the opening of second mounting structure 486 so that forward-facing surfaces of support base 478 are in contact with backward-facing surfaces of back surface 411. In this example, the tension forces may be maintained by support arm 477 between the backward-facing surfaces of opening 476 and the forward-facing surfaces of support base 478.

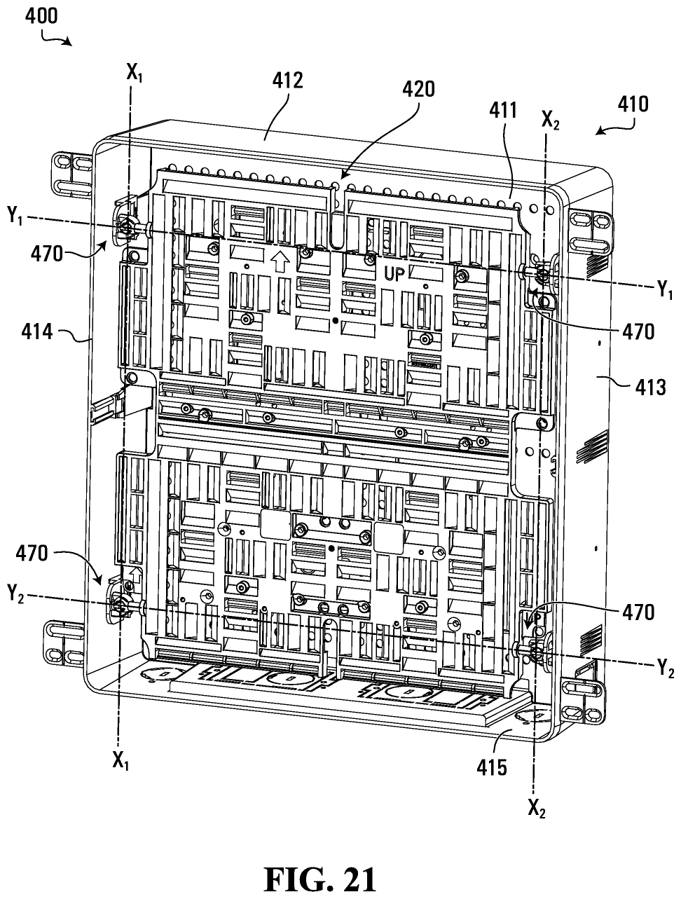

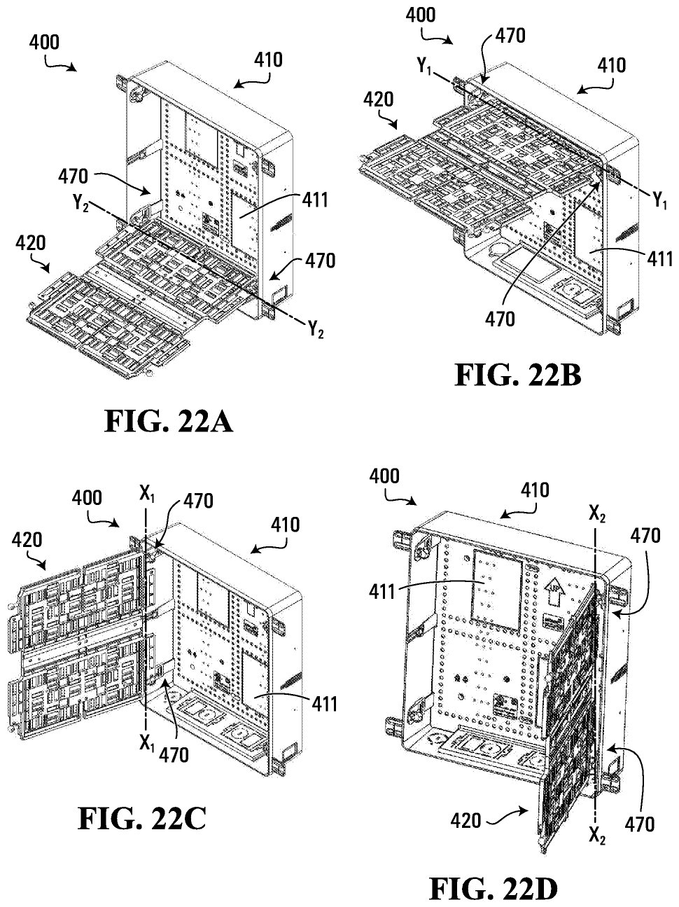

Operational aspects of system 400 are now described with reference to FIG. 21, which depicts one apparatus 420 as being fixed relative to body 410; and FIGS. 22A-D, which depict apparatus 420 as being rotated relative to body 410 in different rotational configurations permitting rotation about one or more different axes extending through body 410, including first axis X1-X1, second axis X2-X2, third axis Y1-Y1, and/or fourth axis Y2-Y2 described above.

As shown in FIG. 21, plurality of hinges 470 may comprise supports 474 (e.g., at least two) at corner positions of body 410 engaged with connectors 472 (e.g., at least two) at corner positions of apparatus 420. Four hinges 470 are shown in FIG. 21, one at each corner position of back surface 411 and apparatus 420. Each connector 472 may be engageable with each support 474. Apparatus 420 may not be movable relative to back surface 411 when at least three hinges 170 are formed, i.e., when at least three connectors 472 are engaged with at least three supports 474. Accordingly, because four connectors 472 are engaged with four supports 474, apparatus 420 of FIG. 21 may be fixed relative to surface 411.

Each hinge 470 may comprise a multi-axis hinge, in which each connector 472 is movable relative to each support 474 about a plurality of different rotational axis. Each hinge 470 may comprise a ball-and-socket joint formed by an interaction between surfaces of connector 472 and surfaces of platform 474. For example, as shown in FIGS. 19 and 20, exterior surfaces of each connector 472 may comprise a spherical shape and interior surfaces of each grasper 479 may comprise a corresponding spherical shape, allowing for multi-axial rotation of each connector 472 relative to each support 474.

Because each hinge 470 may be a multi-axis hinge, apparatus 420 may be rotated relative to body 410 about a plurality of different axes in different rotational configurations by engaging different sets of connectors 472 with different sets of supports 474 without moving any supports 474 relative to body 410. For example, without disengaging any support 474 from body 410, each of: (i) a first (e.g., left) set of hinges 470 may be formed to permit rotation of apparatus 420 about first axis X1-X1 relative to back surface 411, as shown in FIG. 22C; (ii) second (e.g., right) set of hinges 470 may be formed to permit rotation of apparatus 420 about second axis X2-X2 relative to back surface 411, as shown in FIG. 22D; (iii) a third (e.g., top) set of hinges 470 may be formed to permit rotation of apparatus 420 about third axis Y1-Y1 relative to back surface 411, as shown in FIG. 22B; and (iv) a fourth (e.g., bottom) set of hinges 470 may be formed to permit rotation of apparatus 420 about fourth axis Y2-Y2 relative to back surface 411, as shown in FIG. 22A.

Each support 474 may be configured to maintain a distance between back side 424 and back surface 411. For enhanced flexibility, system 400 may comprise a plurality of different supports 474 having different lengths along hinge axis H-H. For example, system 400 may comprise four supports 474 of FIG. 17A and four supports 474B of FIG. 17B. Support body 477 of supports 474 may be configured to located apparatus 420 at a first distance from back surface 411. As above, support 474B of FIG. 17B may be similar to support 474 of FIG. 17A, but with a support body 474B that is configured to locate apparatus 420 at a second distance from back surface 411 that is different from the first distance (e.g., shorter).

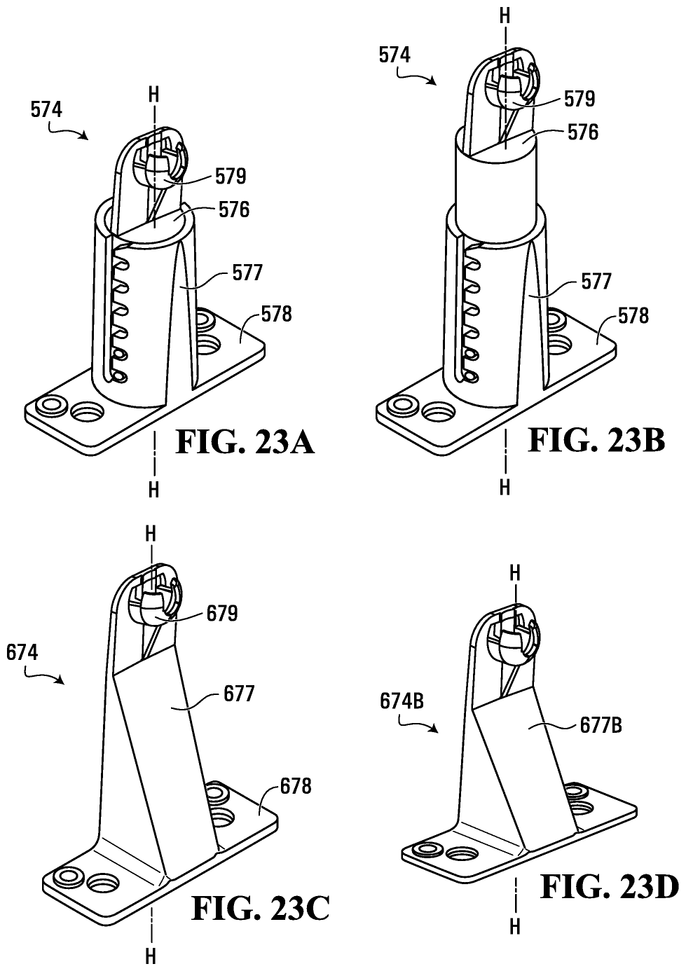

Hinge 470 may be formed with aspects of any hinge structure 174, 274, and/or 374 described above. For example, although described above as being engaged with back surface 411 and side surface 413 or 414, each support 474 also may be spaced apart from side surfaces 413 and 414. Examples are shown in FIGS. 23A and 23B, which depict a support 574 with a support base 578 engageable with back surface 411 in a manner similar to supports 174, 274, and 374; and in FIGS. 23C and 23D, which depict a support 674 with a support base 678 similarly engageable with back surface 411. As a further example, each support 474 also may be variable length hinge so that apparatus 420 may be moved toward or away from back surface 411 to accommodate different objects 10. Examples are shown in FIGS. 23A and 23B, which depict support 574 as comprising a movable support body 576, a fixed support body 577, and a grasper 579 according to their counterpart elements in system 100. As before, each hinge 570 may be operable between a collapsed configuration (FIG. 23A) and an extended configuration (e.g., FIG. 23B).

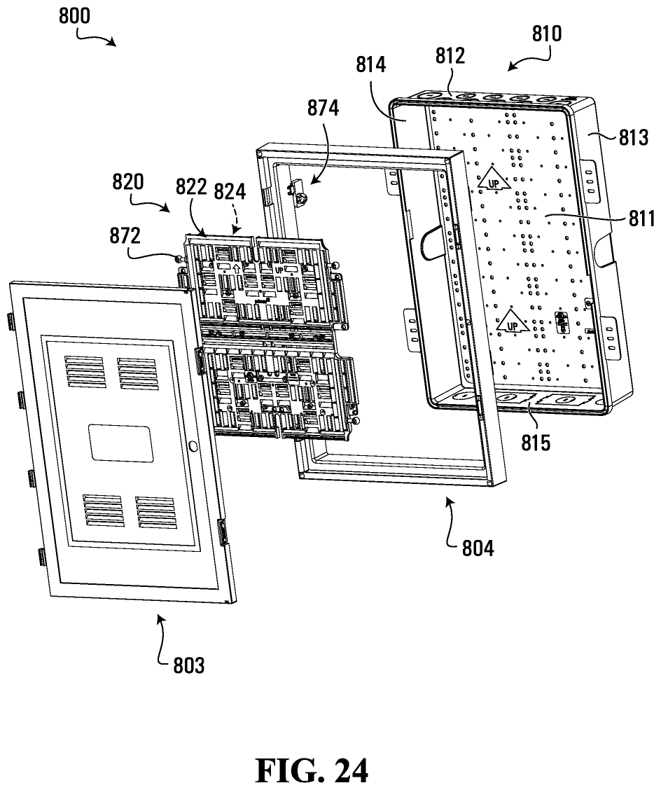

Aspects of this disclosure are now described with reference to an exemplary system 800 shown in FIGS. 24-26 as comprising a lid 802, a body 810, an apparatus 820, and hinges 870. Aspects of system 800 may be similar to counterpart aspects of systems 100 and 400, but within the 800 series of numbers, any such aspects being interchangeable. Aspects of elements of system 800 are now described, followed by descriptions of operational aspects associated therewith.

System 800 demonstrates that elements of hinges 870 also may be engaged with lid 802. As shown in FIG. 24, lid 802 may comprise a panel 803, a frame 804, venting 805, and flanges 806, each of which may be formed and perform similar to their counterparts in systems 100 and/or 400. In contrast to above, panel 803 may be rotatably attached to frame 804 by additional hinges so that panel 803 may be rotated away from body 810 independent of frame 804. As also shown in FIG. 24, body 810 may comprise one or more surfaces similar to their counterparts in systems 100 and/or 400, including a back surface 811, a top surface 812, a first side surface 813, a second side surface 814, and a bottom surface 815, each of which may form an interior cavity and front opening sized to receive apparatus 820.

As shown in FIG. 24, apparatus 820 may comprise a front side 822, a back side 824, and a plurality of securing slots 826 similar to their counterparts in systems 100 and/or 400. For example, each slot 826 may similarly extend through side front side 822 and back side 824 and/or comprise various surfaces engageable with one or more attachment elements 20. As with apparatus 120 and 420, apparatus 820 may comprise a plurality of corner positions (e.g., at least four), and each corner position may comprise at least one connector 872. Although shown as a unibody structure in FIG. 24, apparatus 820 also may comprise separate apparatus portions that are removable and/or joinable to accommodate different objects 10 or bodies 810 having different sizes and/or enhance the installation flexibility of system 800.

As described in system 800, body 810 may comprise (e.g., be engageable with) a plurality of supports 874; apparatus 820 may comprise a plurality of connectors 872; and each connector 872 of plurality of connectors 872 may be engageable with a respective support 874 of plurality of supports 874, wherein, when any one connector 872 of plurality of connectors 872 is engaged with its respective support 874 of plurality of supports 874, a hinge 870 associated with the one connector 872 permits movement of apparatus 820 relative to body 810 about a plurality of different axes of rotation for hinge 870.

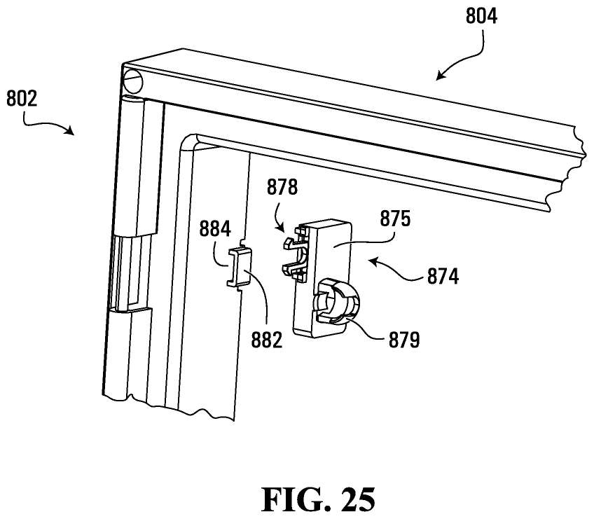

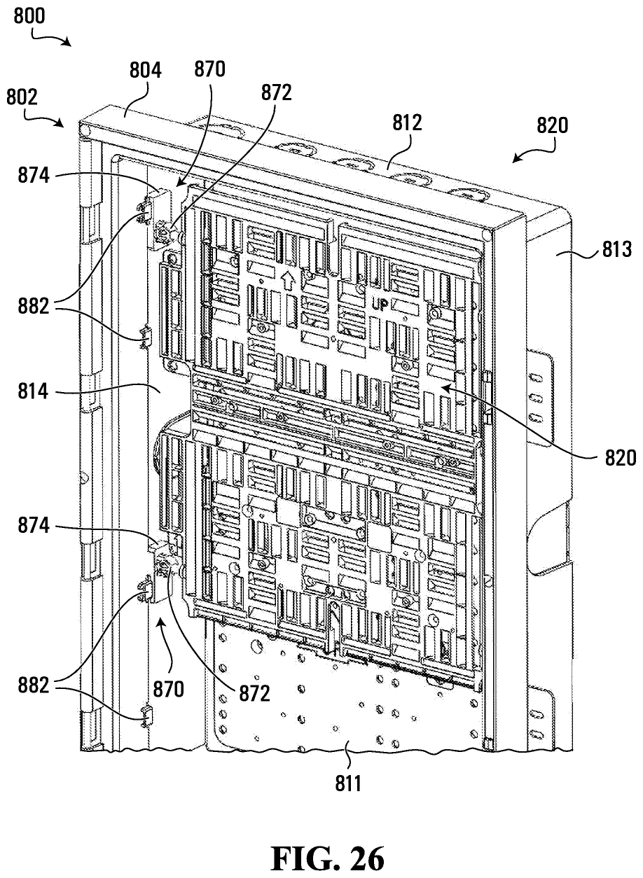

Hinge 870 may be formed when one connector 872 is engaged with its respective support 847. As shown in FIGS. 24 and 26, connectors 872 (e.g., four) may be spaced apart and/or located at corner positions (e.g., four) of apparatus 820; and each connector 872 may be located opposite of another connector 872 along one or more axes extending through apparatus 820. As shown in FIG. 25, each support 874 may comprise a body 875 and a grasper 879 similar to their counterparts in systems 100 and/or 400. Each support 874 also may comprise a support base 878 engageable with a mounting structure 882 of frame 804. As shown in FIG. 25, mounting structure 822 may comprise a channel 884 and support base 878 may comprise a coupler (e.g., a pair of retaining arms) receivable in channel 884.

As shown in FIG. 26, supports 874 (e.g., four) may be spaced apart and/or located at corner positions (e.g., four) of body 810; and each support 874 may be located opposite of another support 874 along one or more axes extending through body 810, allow for rotational configurations of apparatus 820 that are similar to those of apparatus 420 (e.g., as in FIGS. 22A-D). As shown, one mounting structure 882 may located at each corner position, allowing apparatus 820 to be rotatably secured in body 810 without contacting any of surfaces 811-815. As also shown in FIG. 26, frame 804 may comprise additional engagement mounting structures 882 that are engageable with flanges 806 of frame 804 to secure it to body 810.

Aspects of hinge 870 may be combined with any aspects of supports 174, 274, 374, 474, 574, and/or 674 described above. For example, any support 874 may be linearly extendable like supports 174, 274, and 574; and/or system 800 may comprise a plurality of different fixed-length supports 874 allowing apparatus 820 to be secured at different locations relative to back surface 811.

Aspects of this disclosure also may be described with reference to an exemplary kit. For example, as shown in FIGS. 1, 15, and 24 with respect to systems 100, 400, and 800, an exemplary kit may comprise: at least one body 110, 410, 810 comprising a plurality of supports 174, 474, 874; and at least one apparatus 120, 420, 820 comprising a plurality of connectors 172, 472, 872, each connector 172, 472, 872 of the plurality of connectors 172, 472, 872 being engageable with a respective support 174, 474, 874 of the plurality of supports 174, 474, 874, wherein, when any one connector 172, 472, 872 of plurality of connectors 172, 472, 872 of any apparatus 120, 420, 820 is engaged with its respective support 174, 474, 874 of plurality of supports 174, 474, 874 of any body 110, 410, 810, a hinge 170, 470, 820 associated with one connector 172, 472, 872 may permit movement of apparatus 120, 420, 820 relative to body 110, 410, 810 about at least one or a plurality of different axes of rotation for hinge 170, 470, 870.

Other aspects of the present disclosure will become apparent to those ordinarily skilled in the art upon review of the following claims, depictions, and appendices. For example, a skilled artisan would recognize that additional methods and/or kits may be configured based solely on the aspects of the apparatus and systems described herein, whether or not said aspects are described as methods or kits. As a further example, those having ordinary skill in the art and access to the teachings provided herein will recognize the additional modifications, applications, aspects, and substitution of equivalents may all fall in the scope of the aspects described herein. Accordingly, each aspect described and/or depicted herein may be combined with any other aspect described and/or depicted herein, each possible combination and/or iteration being part of this disclosure.

While specific aspects have been described and depicted, these aspects should be considered illustrative of the subject matter described herein and not as limiting the claims as construed in accordance with the relevant jurisprudence. Accordingly, the present disclosure is not to be considered as limited by any particular description and/or depiction set forth herein.

1. A system comprising:
a body comprising a plurality of support surfaces; and
an apparatus comprising a plurality of connector surfaces, each connector surface of the plurality of connector surfaces being engageable with a respective support surface of the plurality of support surfaces,
wherein, when any one connector surface of the plurality of connector surfaces is engaged with its respective support surface of plurality of support surfaces, a multi-axis hinge associated with the one connector surface permits movement of the apparatus relative to the body about a plurality of different axes of rotation for the multi-axis hinge.

2. The system of claim 1, wherein the body comprises one or more body surfaces defining an interior cavity and the apparatus is receivable in the interior cavity.

3. The system of claim 2, comprising a plurality of connector surfaces engageable with the one or more body surfaces, wherein each support surface of the plurality of support surfaces is located on a respective connector surface of the plurality of connector surfaces.

4. The system of claim 3, wherein:
the one or more body surfaces comprise a plurality of mounting structures; and
each connector surface of the plurality of connector surfaces is engageable with a respective mounting structure of the plurality of mounting structures.

5. The system of claim 2, wherein:
the body comprises a lid operable to enclose the interior cavity; and
the lid comprises the plurality of support surfaces.

6. The system of claim 1, wherein:
the plurality of support surfaces comprise a first support surface and a second support surface, and the plurality of connector surfaces comprise a first connector surface and a second connector surface; and
the first and second support surfaces are engageable with the first and second connector surfaces to permit movement of the apparatus relative to the body about a first axis of rotation for the multi-axis hinge.

7. The system of claim 6, wherein:
the plurality of support surfaces comprise a third support surface, and the plurality of connector surfaces comprise a third connector surface; and
the first and third support surfaces are engageable with the first and third connector surfaces to permit movement of the apparatus relative to the body about a second axis of rotation for the multi-axis hinge.

8. The system of claim 7, wherein:
the plurality of support surfaces comprise a fourth support surface, and the plurality of connector surfaces comprise a fourth connector surface; and
the third and fourth support surfaces are engageable with the third and fourth connector surfaces to permit movement of the apparatus relative to the body about a third axis of rotation for the multi-axis hinge.

9. The system of claim 8, wherein:
the first and fourth support surfaces are engageable with the first and fourth connector surfaces to permit movement of the apparatus relative to the body about a fourth axis of rotation for the multi-axis hinge.

10. The system of claim 9, wherein the first axis is parallel with the third axis and the second axis is parallel with the fourth axis.

11. The system of claim 1, wherein the multi-axis hinge comprises a ball-and-socket joint.

12. The system of claim 11, wherein the multi-axis hinge is formed when the one connector surface is engaged with its respective support surface.

13. The system of claim 1, wherein at least a portion of the plurality of support surfaces are linearly adjustable relative to a body surface of the body in order to modify a distance between the multi-axis hinge and the body surface.

14. The system of claim 1, wherein the plurality of support surfaces comprise:
a plurality of first fixed-length supports configured to offset the multi-axis hinge from a body surface of the body by a first distance; and
a plurality of second fixed-length supports configured to offset the multi-axis hinge from the body surface by a second distance.

15. The system of claim 1, wherein each of the plurality of connector surfaces is engageable with each of the plurality of support surfaces.

16. The system of claim 1, wherein the apparatus comprises a first apparatus portion, a second apparatus portion, and a frangible portion joining the first and second portions.

17. The system of claim 1, wherein the apparatus comprises:
first securing slots located in an interior portion of the apparatus and operable with an attachment element to secure objects to a front side of the apparatus;
second securing slots located in the interior portion and operable with the attachment element to secure the objects to a back side of the apparatus; and
third securing slots located on a perimeter of the interior portion and operable with the attachment element to secure the objects to the front or back side of the apparatus, each third slot having a longitudinal dimension that is greater than a respective longitudinal dimension of each first and second slot.

18. A kit comprising:
at least one body comprising a plurality of support surfaces; and
at least one apparatus comprising a plurality of connector surfaces, each connector surface of the plurality of connector surfaces being engageable with a respective support surface of the plurality of support surfaces,
wherein, when any one connector surface of the plurality of connector surfaces of any apparatus is engaged with its respective support surface of plurality of support surfaces of any body, a multi-axis hinge associated with the one connector surface permits movement of the apparatus relative to the body about a plurality of different axes of rotation for the multi-axis hinge.

19. The kit of claim 18, comprising at least one of:
an attachment element operable to secure the body to another surface;
an attachment element operable to secure objects to the apparatus; and
instructions associated with the body or the apparatus.

20. A system comprising:
a body comprising a plurality of support surfaces; and
an apparatus comprising a plurality of connector surfaces, each connector surface of the plurality of connector surfaces being engageable with a respective support surface of the plurality of support surfaces,
wherein, when any one connector surface of the plurality of connector surfaces is engaged with its respective support surface of plurality of support surfaces, a hinge means for moving the apparatus relative to the body permits movement of the apparatus relative to the body about a plurality of different axes of rotation for the hinge means.
